(19) United States
(12) Patent Application Publication
(10) Pub. No.: US 2023/0012787 A1
(43) Pub. Date: Jan. 19, 2023

(54) ACCESSING INTERNAL NETWORK RESOURCES USING APPLICATION CUSTOM TAB

(71) Applicant: Citrix Systems, Inc., Fort Lauderdale, FL (US)

(72) Inventors: Nimish Agarwal, Bangalore (IN); Ravi Kumar Bhojwani, Bangalore (IN); Sanket Garg, Bangalore (IN); Vivek Joshi, Bangalore (IN)

(21) Appl. No.: 17/379,771

(22) Filed: Jul. 19, 2021

(51) Int. Cl. G06F 3/0483; H04L 12/46; H04L 29/08

(52) U.S. Cl. CPC G06F 3/0483; H04L 12/4641; H04L 67/146; H04L 67/141

(57) ABSTRACT

Methods, apparatuses, and systems for accessing internal network resources using application custom tab are described herein. A first application implemented on a computing device may present a link pointing to a resource of an internal network. After selection of the link, a web browsing tab of a second application may be used to access the link and/or to render a web page corresponding to the link. The web browsing tab may establish a connection with the internal network, and/or may access the resource of the internal network via the connection. The web browsing tab of the second application may be customized by the first application.

### FIELD

Aspects described herein generally relate to computer networking, applications, enterprise mobility management, and hardware and software related thereto. More specifically, one or more aspects are described for accessing internal network resources using application custom tab.

### BACKGROUND

An application may be implemented on a computing device. The application may present a link on the user interface of the application. A user, intending to access the link, may click the link. If the link points to a resource located in an internal or private network associated with an enterprise organization, the application might not be able to directly access the link via the public network, and the user may have to find some other access method.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards methods, apparatuses, and/or systems for accessing internal network resources using application custom tab. A first application implemented by a computing device may receive a selection of a link from a user interface of the first application. The first application may invoke a web browsing tab of a second application implemented by the computing device. The web browsing tab may be customized to the first application. The web browsing tab of the second application may determine that the link comprises an internal link associated with an internal network. Based on the determining, the web browsing tab may establish a virtual private network (VPN) connection with the internal network. The web browsing tab may access, via the VPN connection, a resource identified by the link. Based on the accessing, the web browsing tab may render a web page associated with the link.

In some examples, the invoking the web browsing tab may comprise inputting, to the web browsing tab, the link.

In some examples, the customization of the web browsing tab to the first application may comprise adjusting, based on the user interface of the first application, a user interface of the web browsing tab.

In some examples, a transition animation, displayed via a user interface, for switching from the first application to the web browsing tab may be less indicative of context switching than a transaction animation, displayed via a user interface, for switching from the first application to another application.

In some examples, the second application may authenticate, based on user credentials, to an authentication server associated with the internal network. The second application may receive, from the authentication server, an authentication token. The second application may request, based on the authentication token and for the web browsing tab, a session cookie. The establishing the VPN connection with the internal network may be based on the session cookie.

In some examples, the second application may authenticate, based on user credentials, to an authentication server associated with the internal network. The second application may receive, from the authentication server, an authentication token. The establishing the VPN connection with the internal network may be based on the authentication token.

In some examples, a third application implemented by the computing device may receive a selection of a second link from a user interface of the third application. The third application may query, via an inter-application communication channel, the second application. Based on the querying, the third application may determine whether the second link comprises an internal link associated with the internal network. Based on the determining whether the second link comprises an internal link associated with the internal network, the third application may determine whether to invoke a web browsing tab, of the second application, customized to the third application.

In some examples, the link may comprise a uniform resource locator (URL).

In some examples, the second application may receive a policy file indicating restrictions on use of the web browsing tab. The restrictions may be specific to one or more of applications, links, or users.

In some examples, the use of the web browsing tab may comprise one or more of: invoking the web browsing tab; copying content from the web browsing tab; adding watermarks on web pages rendered by the web browsing tab; printing content from the web browsing tab; downloading content from the web browsing tab; or communicating via an inter-application communication channel with the second application.

In some examples, the internal network may comprise a private network of an enterprise organization.

In some examples, the VPN connection may comprise a first end point and a second end point. The first end point may be limited to the web browsing tab. The second end point may be limited to the resource.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative enterprise mobility management system.

FIG. 6 depicts another illustrative enterprise mobility management system.

FIG. 7 is a schematic diagram showing an example system in which various aspects described herein may be implemented.

FIG. 8 is a schematic diagram showing an example system for accessing internal network resources using an application custom tab in accordance with one or more aspects described herein.

FIGS. 9A-9B show a flowchart of an example method for accessing internal network resources using an application custom tab in accordance with one or more aspects described herein.

FIGS. 10A-10B show a flowchart of another example method for accessing internal network resources using an application custom tab in accordance with one or more aspects described herein.

FIG. 11 shows an example user interface in accordance with one or more aspects described herein.

FIG. 12 shows another example user interface in accordance with one or more aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards methods, apparatuses, and systems for accessing internal network resources using application custom tab. A first application implemented on a computing device may present a link pointing to a resource of an internal network. After selection of the link, a web browsing tab of a second application may be used to access the link and/or to render a web page corresponding to the link. The web browsing tab may establish a connection with the internal network, and/or may access the resource of the internal network via the connection. The web browsing tab of the second application may be customized by the first application.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

Computing Architecture

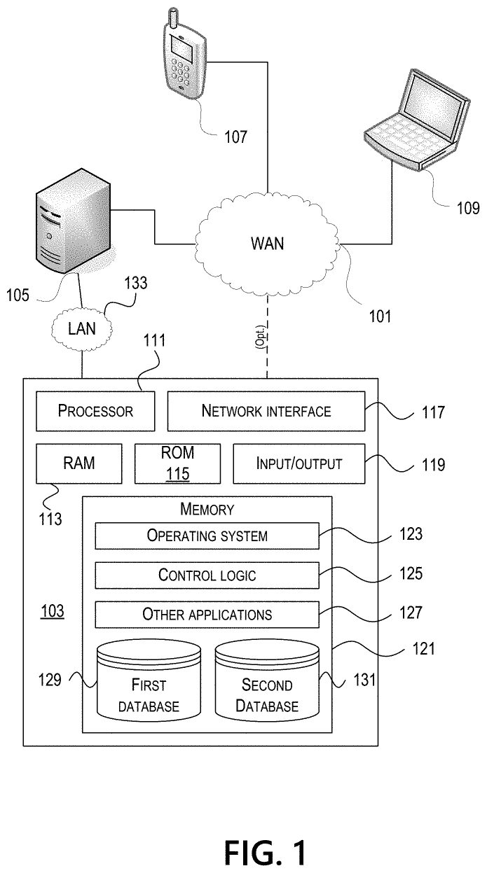

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data— attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

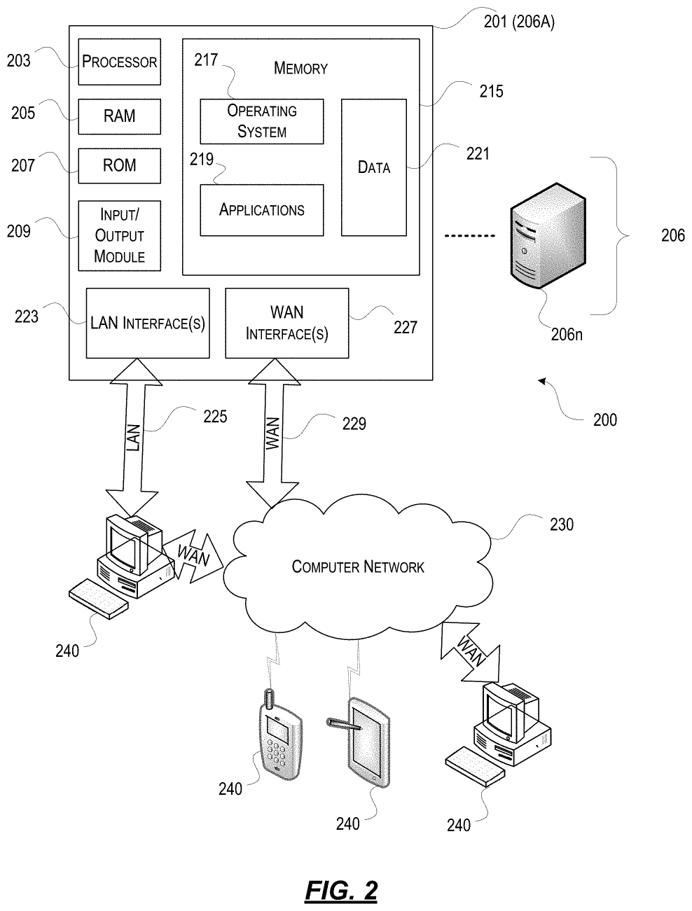

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

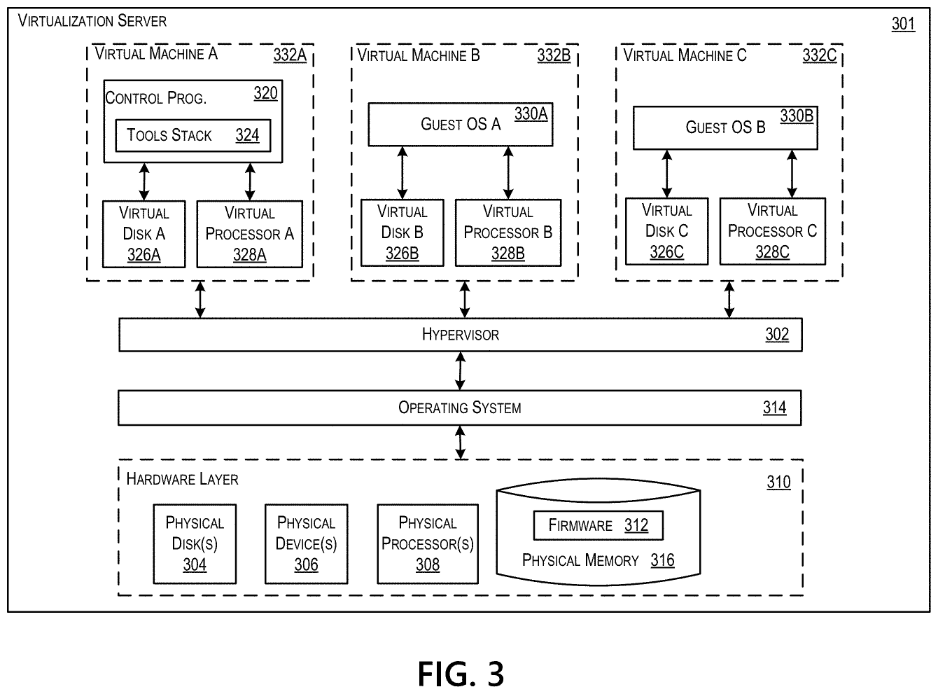

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

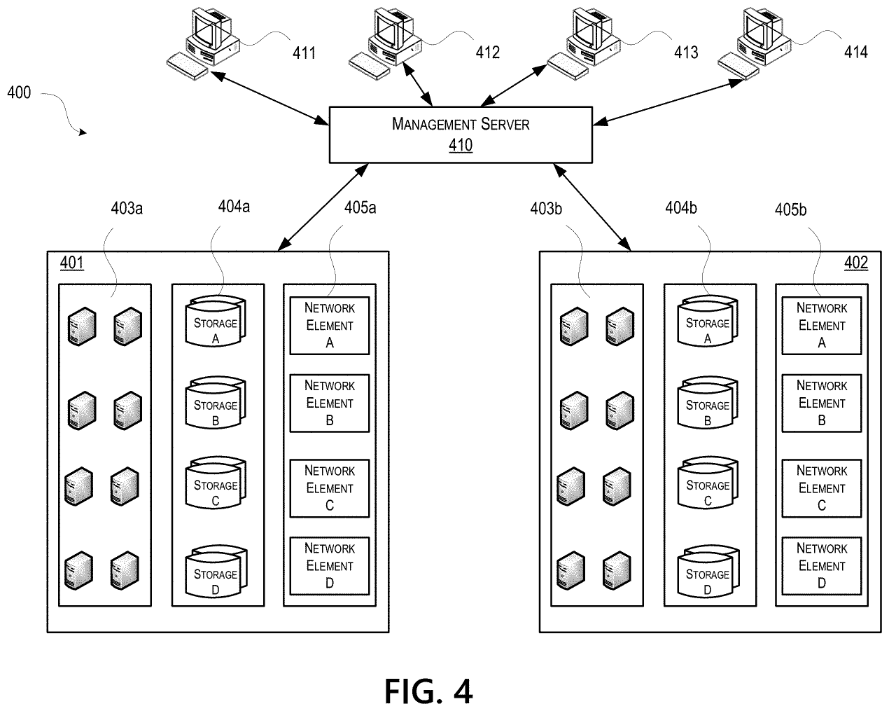

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

Enterprise Mobility Management Architecture

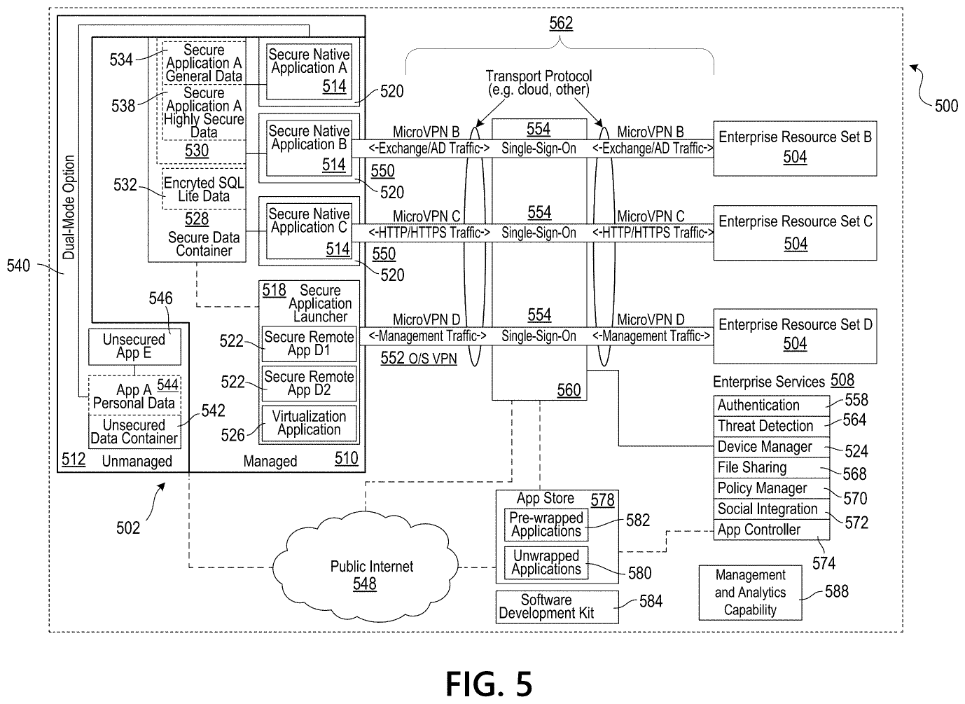

FIG. 5 represents an enterprise mobility technical architecture 500 for use in a “Bring Your Own Device” (BYOD) environment. The architecture enables a user of a mobile device 502 to both access enterprise or personal resources from a mobile device 502 and use the mobile device 502 for personal use. The user may access such enterprise resources 504 or enterprise services 508 using a mobile device 502 that is purchased by the user or a mobile device 502 that is provided by the enterprise to the user. The user may utilize the mobile device 502 for business use only or for business and personal use. The mobile device 502 may run an iOS operating system, an Android operating system, or the like. The enterprise may choose to implement policies to manage the mobile device 502. The policies may be implemented through a firewall or gateway in such a way that the mobile device 502 may be identified, secured or security verified, and provided selective or full access to the enterprise resources (e.g., 504 and 508.) The policies may be mobile device management policies, mobile application management policies, mobile data management policies, or some combination of mobile device, application, and data management policies. A mobile device 502 that is managed through the application of mobile device management policies may be referred to as an enrolled device.

In some embodiments, the operating system of the mobile device 502 may be separated into a managed partition 510 and an unmanaged partition 512. The managed partition 510 may have policies applied to it to secure the applications running on and data stored in the managed partition 510. The applications running on the managed partition 510 may be secure applications. In other embodiments, all applications may execute in accordance with a set of one or more policy files received separate from the application, and which define one or more security parameters, features, resource restrictions, and/or other access controls that are enforced by the mobile device management system when that application is executing on the mobile device 502. By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple applications as described herein (virtual partition). Stated differently, by enforcing policies on managed applications, those applications may be restricted to only be able to communicate with other managed applications and trusted enterprise resources, thereby creating a virtual partition that is not accessible by unmanaged applications and devices.

The secure applications may be email applications, web browsing applications, software-as-a-service (SaaS) access applications, Windows Application access applications, and the like. The secure applications may be secure native applications 514, secure remote applications 522 executed by a secure application launcher 518, virtualization applications 526 executed by a secure application launcher 518, and the like. The secure native applications 514 may be wrapped by a secure application wrapper 520. The secure application wrapper 520 may include integrated policies that are executed on the mobile device 502 when the secure native application 514 is executed on the mobile device 502. The secure application wrapper 520 may include meta-data that points the secure native application 514 running on the mobile device 502 to the resources hosted at the enterprise (e.g., 504 and 508) that the secure native application 514 may require to complete the task requested upon execution of the secure native application 514. The secure remote applications 522 executed by a secure application launcher 518 may be executed within the secure application launcher 518. The virtualization applications 526 executed by a secure application launcher 518 may utilize resources on the mobile device 502, at the enterprise resources 504, and the like. The resources used on the mobile device 502 by the virtualization applications 526 executed by a secure application launcher 518 may include user interaction resources, processing resources, and the like. The user interaction resources may be used to collect and transmit keyboard input, mouse input, camera input, tactile input, audio input, visual input, gesture input, and the like. The processing resources may be used to present a user interface, process data received from the enterprise resources 504, and the like. The resources used at the enterprise resources 504 by the virtualization applications 526 executed by a secure application launcher 518 may include user interface generation resources, processing resources, and the like. The user interface generation resources may be used to assemble a user interface, modify a user interface, refresh a user interface, and the like. The processing resources may be used to create information, read information, update information, delete information, and the like. For example, the virtualization application 526 may record user interactions associated with a graphical user interface (GUI) and communicate them to a server application where the server application will use the user interaction data as an input to the application operating on the server. In such an arrangement, an enterprise may elect to maintain the application on the server side as well as data, files, etc. associated with the application. While an enterprise may elect to “mobilize” some applications in accordance with the principles herein by securing them for deployment on the mobile device 502, this arrangement may also be elected for certain applications. For example, while some applications may be secured for use on the mobile device 502, others might not be prepared or appropriate for deployment on the mobile device 502 so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for the mobile device 502 so the enterprise may elect to provide access to the application through virtualization techniques. As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data. An enterprise may elect to provide both fully secured and fully functional applications on the mobile device 502 as well as a virtualization application 526 to allow access to applications that are deemed more properly operated on the server side. In an embodiment, the virtualization application 526 may store some data, files, etc. on the mobile device 502 in one of the secure storage locations. An enterprise, for example, may elect to allow certain information to be stored on the mobile device 502 while not permitting other information.

In connection with the virtualization application 526, as described herein, the mobile device 502 may have a virtualization application 526 that is designed to present GUIs and then record user interactions with the GUI. The virtualization application 526 may communicate the user interactions to the server side to be used by the server side application as user interactions with the application. In response, the application on the server side may transmit back to the mobile device 502 a new GUI. For example, the new GUI may be a static page, a dynamic page, an animation, or the like, thereby providing access to remotely located resources.

The secure applications 514 may access data stored in a secure data container 528 in the managed partition 510 of the mobile device 502. The data secured in the secure data container may be accessed by the secure native applications 514, secure remote applications 522 executed by a secure application launcher 518, virtualization applications 526 executed by a secure application launcher 518, and the like. The data stored in the secure data container 528 may include files, databases, and the like. The data stored in the secure data container 528 may include data restricted to a specific secure application 530, shared among secure applications 532, and the like. Data restricted to a secure application may include secure general data 534 and highly secure data 538. Secure general data may use a strong form of encryption such as Advanced Encryption Standard (AES) 128-bit encryption or the like, while highly secure data 538 may use a very strong form of encryption such as AES 256-bit encryption. Data stored in the secure data container 528 may be deleted from the mobile device 502 upon receipt of a command from the device manager 524. The secure applications (e.g., 514, 522, and 526) may have a dual-mode option 540. The dual mode option 540 may present the user with an option to operate the secured application in an unsecured or unmanaged mode. In an unsecured or unmanaged mode, the secure applications may access data stored in an unsecured data container 542 on the unmanaged partition 512 of the mobile device 502. The data stored in an unsecured data container may be personal data 544. The data stored in an unsecured data container 542 may also be accessed by unsecured applications 546 that are running on the unmanaged partition 512 of the mobile device 502. The data stored in an unsecured data container 542 may remain on the mobile device 502 when the data stored in the secure data container 528 is deleted from the mobile device 502. An enterprise may want to delete from the mobile device 502 selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

The mobile device 502 may connect to enterprise resources 504 and enterprise services 508 at an enterprise, to the public Internet 548, and the like. The mobile device 502 may connect to enterprise resources 504 and enterprise services 508 through virtual private network connections. The virtual private network connections, also referred to as microVPN or application-specific VPN, may be specific to particular applications (as illustrated by microVPNs 550, particular devices, particular secured areas on the mobile device (as illustrated by O/S VPN 552), and the like. For example, each of the wrapped applications in the secured area of the mobile device 502 may access enterprise resources through an application specific VPN such that access to the VPN would be granted based on attributes associated with the application, possibly in conjunction with user or device attribute information. The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 554. The single-sign-on processes may allow a user to provide a single set of authentication credentials, which are then verified by an authentication service 558. The authentication service 558 may then grant to the user access to multiple enterprise resources 504, without requiring the user to provide authentication credentials to each individual enterprise resource 504.

The virtual private network connections may be established and managed by an access gateway 560. The access gateway 560 may include performance enhancement features that manage, accelerate, and improve the delivery of enterprise resources 504 to the mobile device 502. The access gateway 560 may also re-route traffic from the mobile device 502 to the public Internet 548, enabling the mobile device 502 to access publicly available and unsecured applications that run on the public Internet 548. The mobile device 502 may connect to the access gateway via a transport network 562. The transport network 562 may use one or more transport protocols and may be a wired network, wireless network, cloud network, local area network, metropolitan area network, wide area network, public network, private network, and the like.

The enterprise resources 504 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. The enterprise resources 504 may be premise-based resources, cloud-based resources, and the like. The enterprise resources 504 may be accessed by the mobile device 502 directly or through the access gateway 560. The enterprise resources 504 may be accessed by the mobile device 502 via the transport network 562.

The enterprise services 508 may include authentication services 558, threat detection services 564, device manager services 524, file sharing services 568, policy manager services 570, social integration services 572, application controller services 574, and the like. Authentication services 558 may include user authentication services, device authentication services, application authentication services, data authentication services, and the like. Authentication services 558 may use certificates. The certificates may be stored on the mobile device 502, by the enterprise resources 504, and the like. The certificates stored on the mobile device 502 may be stored in an encrypted location on the mobile device 502, the certificate may be temporarily stored on the mobile device 502 for use at the time of authentication, and the like. Threat detection services 564 may include intrusion detection services, unauthorized access attempt detection services, and the like. Unauthorized access attempt detection services may include unauthorized attempts to access devices, applications, data, and the like. Device management services 524 may include configuration, provisioning, security, support, monitoring, reporting, and decommissioning services. File sharing services 568 may include file management services, file storage services, file collaboration services, and the like. Policy manager services 570 may include device policy manager services, application policy manager services, data policy manager services, and the like. Social integration services 572 may include contact integration services, collaboration services, integration with social networks such as Facebook, Twitter, and LinkedIn, and the like. Application controller services 574 may include management services, provisioning services, deployment services, assignment services, revocation services, wrapping services, and the like.

The enterprise mobility technical architecture 500 may include an application store 578. The application store 578 may include unwrapped applications 580, pre-wrapped applications 582, and the like. Applications may be populated in the application store 578 from the application controller 574. The application store 578 may be accessed by the mobile device 502 through the access gateway 560, through the public Internet 548, or the like. The application store 578 may be provided with an intuitive and easy to use user interface.

A software development kit 584 may provide a user the capability to secure applications selected by the user by wrapping the application as described previously in this description. An application that has been wrapped using the software development kit 584 may then be made available to the mobile device 502 by populating it in the application store 578 using the application controller 574.

The enterprise mobility technical architecture 500 may include a management and analytics capability 588. The management and analytics capability 588 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

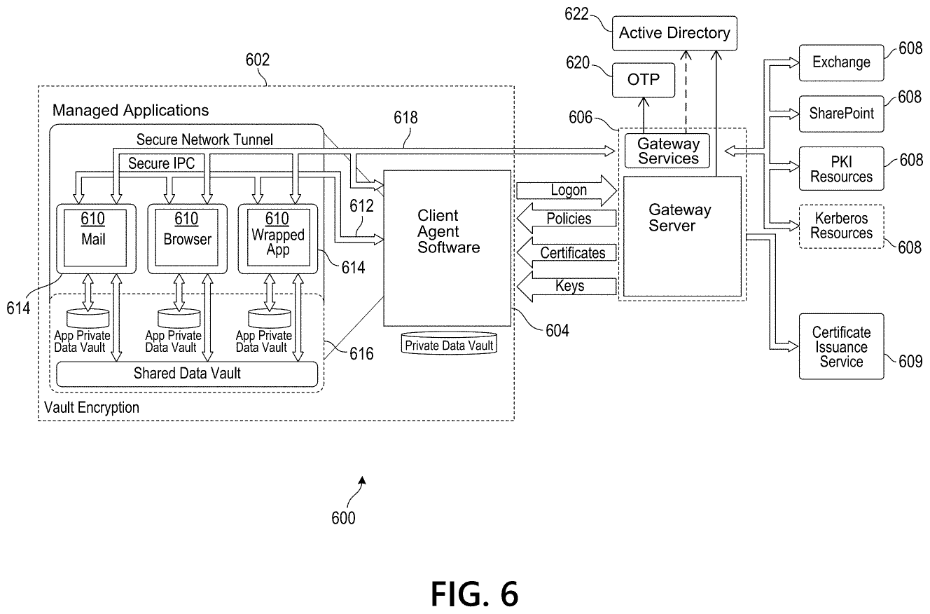

FIG. 6 is another illustrative enterprise mobility management system 600. Some of the components of the mobility management system 500 described above with reference to FIG. 5 have been omitted for the sake of simplicity. The architecture of the system 600 depicted in FIG. 6 is similar in many respects to the architecture of the system 500 described above with reference to FIG. 5 and may include additional features not mentioned above.

In this case, the left hand side represents an enrolled mobile device 602 with a client agent 604, which interacts with gateway server 606 (which includes Access Gateway and application controller functionality) to access various enterprise resources 608 and services 609 such as Exchange, Sharepoint, public-key infrastructure (PKI) Resources, Kerberos Resources, Certificate Issuance service, as shown on the right hand side above. Although not specifically shown, the mobile device 602 may also interact with an enterprise application store (StoreFront) for the selection and downloading of applications.

The client agent 604 acts as the UI (user interface) intermediary for Windows apps/desktops hosted in an Enterprise data center, which are accessed using the High-Definition User Experience (HDX)/ICA display remoting protocol. The client agent 604 also supports the installation and management of native applications on the mobile device 602, such as native iOS or Android applications. For example, the managed applications 610 (mail, browser, wrapped application) shown in the figure above are all native applications that execute locally on the mobile device 602. Client agent 604 and application management framework of this architecture act to provide policy driven management capabilities and features such as connectivity and SSO (single sign on) to enterprise resources/services 608. The client agent 604 handles primary user authentication to the enterprise, normally to Access Gateway (AG) 606 with SSO to other gateway server components. The client agent 604 obtains policies from gateway server 606 to control the behavior of the managed applications 610 on the mobile device 602.

The Secure InterProcess Communication (IPC) links 612 between the native applications 610 and client agent 604 represent a management channel, which may allow a client agent to supply policies to be enforced by the application management framework 614 “wrapping” each application. The IPC channel 612 may also allow client agent 604 to supply credential and authentication information that enables connectivity and SSO to enterprise resources 608. Finally, the IPC channel 612 may allow the application management framework 614 to invoke user interface functions implemented by client agent 604, such as online and offline authentication.

Communications between the client agent 604 and gateway server 606 are essentially an extension of the management channel from the application management framework 614 wrapping each native managed application 610. The application management framework 614 may request policy information from client agent 604, which in turn may request it from gateway server 606. The application management framework 614 may request authentication, and client agent 604 may log into the gateway services part of gateway server 606 (for example, Citrix Gateway). Client agent 604 may also call supporting services on gateway server 606, which may produce input material to derive encryption keys for the local data vaults 616, or may provide client certificates which may enable direct authentication to PKI protected resources, as more fully explained below.

In more detail, the application management framework 614 “wraps” each managed application 610. This may be incorporated via an explicit build step, or via a post-build processing step. The application management framework 614 may “pair” with client agent 604 on first launch of an application 610 to initialize the Secure IPC channel 612 and obtain the policy for that application. The application management framework 614 may enforce relevant portions of the policy that apply locally, such as the client agent login dependencies and some of the containment policies that restrict how local OS services may be used, or how they may interact with the managed application 610.

The application management framework 614 may use services provided by client agent 604 over the Secure IPC channel 612 to facilitate authentication and internal network access. Key management for the private and shared data vaults 616 (containers) may be also managed by appropriate interactions between the managed applications 610 and client agent 604. Vaults 616 may be available only after online authentication, or may be made available after offline authentication if allowed by policy. First use of vaults 616 may require online authentication, and offline access may be limited to at most the policy refresh period before online authentication is again required.

Network access to internal resources may occur directly from individual managed applications 610 through Access Gateway 606. The application management framework 614 may be responsible for orchestrating the network access on behalf of each managed application 610. Client agent 604 may facilitate these network connections by providing suitable time limited secondary credentials obtained following online authentication. Multiple modes of network connection may be used, such as reverse web proxy connections and end-to-end VPN-style tunnels 618.

The Mail and Browser managed applications 610 have special status and may make use of facilities that might not be generally available to arbitrary wrapped applications. For example, the Mail application 610 may use a special background network access mechanism that allows it to access an Exchange server 608 over an extended period of time without requiring a full AG logon. The Browser application 610 may use multiple private data vaults 616 to segregate different kinds of data.

This architecture may support the incorporation of various other security features. For example, gateway server 606 (including its gateway services) in some cases may not need to validate active directory (AD) passwords. It can be left to the discretion of an enterprise whether an AD password may be used as an authentication factor for some users in some situations. Different authentication methods may be used if a user is online or offline (i.e., connected or not connected to a network).

Step up authentication is a feature wherein gateway server 606 may identify managed native applications 610 that are allowed to have access to highly classified data requiring strong authentication, and ensure that access to these applications is only permitted after performing appropriate authentication, even if this means a re-authentication is required by the user after a prior weaker level of login.

Another security feature of this solution is the encryption of the data vaults 616 (containers) on the mobile device 602. The vaults 616 may be encrypted so that all on-device data including files, databases, and configurations are protected. For on-line vaults, the keys may be stored on the server (gateway server 606), and for off-line vaults, a local copy of the keys may be protected by a user password or biometric validation. If or when data is stored locally on the mobile device 602 in the secure container 616, it may be preferred that a minimum of AES 256 encryption algorithm be utilized.

Other secure container features may also be implemented. For example, a logging feature may be included, wherein security events happening inside a managed application 610 may be logged and reported to the backend. Data wiping may be supported, such as if or when the managed application 610 detects tampering, associated encryption keys may be written over with random data, leaving no hint on the file system that user data was destroyed. Screenshot protection may be another feature, where an application may prevent any data from being stored in screenshots. For example, the key window's hidden property may be set to YES. This may cause whatever content is currently displayed on the screen to be hidden, resulting in a blank screenshot where any content would normally reside.

Local data transfer may be prevented, such as by preventing any data from being locally transferred outside the application container, e.g., by copying it or sending it to an external application. A keyboard cache feature may operate to disable the autocorrect functionality for sensitive text fields. SSL certificate validation may be operable so the application specifically validates the server SSL certificate instead of it being stored in the keychain. An encryption key generation feature may be used such that the key used to encrypt data on the mobile device 602 is generated using a passphrase or biometric data supplied by the user (if offline access is required). It may be XORed with another key randomly generated and stored on the server side if offline access is not required. Key Derivation functions may operate such that keys generated from the user password use KDFs (key derivation functions, notably Password-Based Key Derivation Function 2 (PBKDF2)) rather than creating a cryptographic hash of it. The latter makes a key susceptible to brute force or dictionary attacks.

Further, one or more initialization vectors may be used in encryption methods. An initialization vector will cause multiple copies of the same encrypted data to yield different cipher text output, preventing both replay and cryptanalytic attacks. This will also prevent an attacker from decrypting any data even with a stolen encryption key. Further, authentication then decryption may be used, wherein application data is decrypted only after the user has authenticated within the application. Another feature may relate to sensitive data in memory, which may be kept in memory (and not in disk) only when it's needed. For example, login credentials may be wiped from memory after login, and encryption keys and other data inside objective-C instance variables are not stored, as they may be easily referenced. Instead, memory may be manually allocated for these.

An inactivity timeout may be implemented, wherein after a policy-defined period of inactivity, a user session is terminated.

Data leakage from the application management framework 614 may be prevented in other ways. For example, if or when a managed application 610 is put in the background, the memory may be cleared after a predetermined (configurable) time period. When backgrounded, a snapshot may be taken of the last displayed screen of the application to fasten the foregrounding process. The screenshot may contain confidential data and hence should be cleared.

Another security feature may relate to the use of an OTP (one time password) 620 without the use of an AD (active directory) 622 password for access to one or more applications. In some cases, some users do not know (or are not permitted to know) their AD password, so these users may authenticate using an OTP 620 such as by using a hardware OTP system like SecurID (OTPs may be provided by different vendors also, such as Entrust or Gemalto). In some cases, after a user authenticates with a user ID, a text may be sent to the user with an OTP 620. In some cases, this may be implemented only for online use, with a prompt being a single field.

An offline password may be implemented for offline authentication for those managed applications 610 for which offline use is permitted via enterprise policy. For example, an enterprise may want StoreFront to be accessed in this manner In this case, the client agent 604 may require the user to set a custom offline password and the AD password is not used. Gateway server 606 may provide policies to control and enforce password standards with respect to the minimum length, character class composition, and age of passwords, such as described by the standard Windows Server password complexity requirements, although these requirements may be modified.

Another feature may relate to the enablement of a client side certificate for certain applications 610 as secondary credentials (for the purpose of accessing PKI protected web resources via the application management framework micro VPN feature). For example, a managed application 610 may utilize such a certificate. In this case, certificate-based authentication using ActiveSync protocol may be supported, wherein a certificate from the client agent 604 may be retrieved by gateway server 606 and used in a keychain. Each managed application 610 may have one associated client certificate, identified by a label that is defined in gateway server 606.

Gateway server 606 may interact with an enterprise special purpose web service to support the issuance of client certificates to allow relevant managed applications to authenticate to internal PKI protected resources.

The client agent 604 and the application management framework 614 may be enhanced to support obtaining and using client certificates for authentication to internal PKI protected network resources. More than one certificate may be supported, such as to match various levels of security and/or separation requirements. The certificates may be used by the Mail and Browser managed applications 610, and ultimately by arbitrary wrapped applications 610 (provided those applications use web service style communication patterns where it is reasonable for the application management framework to mediate HTTPS requests).

Application management client certificate support on iOS may rely on importing a public-key cryptography standards (PKCS) 12 BLOB (Binary Large Object) into the iOS keychain in each managed application 610 for each period of use. Application management framework client certificate support may use a HTTPS implementation with private in-memory key storage. The client certificate may not be present in the iOS keychain and may not be persisted except potentially in “online-only” data value that is strongly protected.

Mutual SSL or TLS may also be implemented to provide additional security by requiring that a mobile device 602 is authenticated to the enterprise, and vice versa. Virtual smart cards for authentication to gateway server 606 may also be implemented.

Another feature may relate to application container locking and wiping, which may automatically occur upon jail-break or rooting detections, and occur as a pushed command from administration console, and may include a remote wipe functionality even when a managed application 610 is not running.

A multi-site architecture or configuration of enterprise application store and an application controller may be supported that allows users to be serviced from one of several different locations in case of failure.

In some cases, managed applications 610 may be allowed to access a certificate and private key via an API (for example, OpenSSL). Trusted managed applications 610 of an enterprise may be allowed to perform specific Public Key operations with an application's client certificate and private key. Various use cases may be identified and treated accordingly, such as if or when an application behaves like a browser and no certificate access is required, if or when an application reads a certificate for “who am I,” if or when an application uses the certificate to build a secure session token, and if or when an application uses private keys for digital signing of important data (e.g. transaction log) or for temporary data encryption.

Accessing Internal Network Resources Using Application Custom Tab

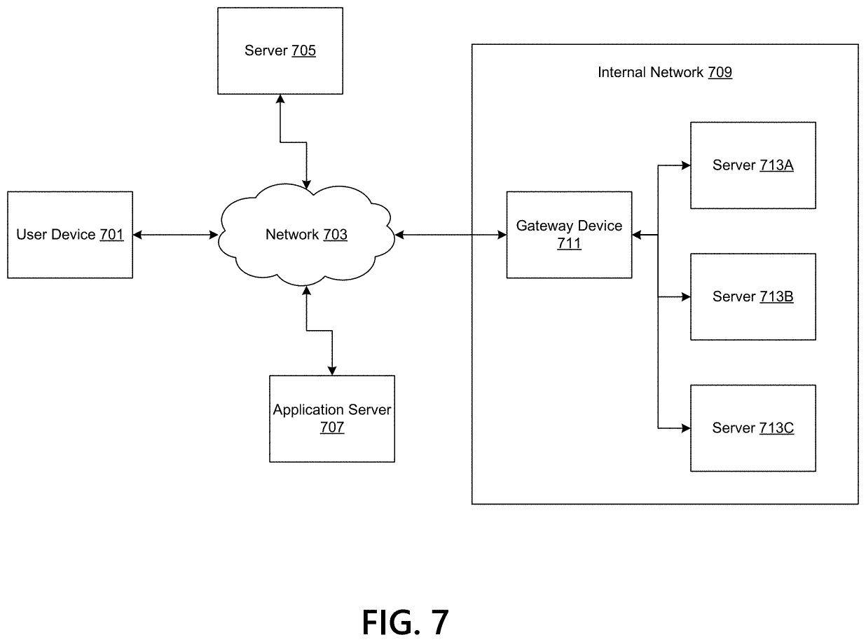

FIG. 7 is a schematic diagram showing an example system in which various aspects described herein may be implemented. The system may comprise one or more user devices (e.g., user device 701), one or more networks (e.g., network 703), one or more servers (e.g., servers 705, 713A-713C), one or more application servers (e.g., application server 707), one or more internal networks (e.g., internal network 709), and one or more gateway devices (e.g., gateway device 711).

The user device 701 may comprise, for example, a smartphone, a personal computer, a tablet, a desktop computer, a laptop computer, a gaming device, a virtual reality headset, or any other computing device. Additionally, the user device 701 may comprise, for example, the computers 107, 109, the terminals 240, the client computers 411-414, the mobile device 502, or the mobile device 602 as discussed above in connection with FIGS. 1-2 and 4-6.

The network 703 may comprise a single network or a collection of multiple connected networks. The network 703 may comprise one or more of any of various types of information distribution networks, such as, without limitation, a satellite network, a telephone network, a cellular network, a Wi-Fi network, an Ethernet network, an optical fiber network, a coaxial cable network, a hybrid fiber coax network, etc. The network 703 may comprise a local area network (LAN), a wide area network (WAN), a backbone network, etc. The network 703 may comprise an Internet Protocol (IP) based network (e.g., the Internet). The network 703 may comprise a plurality of interconnected communication links (e.g., to connect the user device 701, the server 705, the application server 707, the gateway device 711, and/or other devices).

The server 705 may comprise any type of computing device. The server 705 may comprise, for example, a web server. The server 705 may be identified by one or more uniform resource locators (URLs) or web addresses. The server 705 may be accessible via the network 705 (e.g., the Internet). The server 705 may be configured to provide web pages to requesting devices. For example, a web browser may be implemented by the user device 701, and may receive user input corresponding to a web address identifying the server 705. The web browser may then request a web page from the server 705. In response, the server 705 may send the web page to the user device 701 for rendering via the web browser.

The application server 707 may comprise any type of computing device. The application server 707 may be configured to provide content, assets, and/or other information for applications running on client devices (e.g., the user device 701). For example, a mobile application may be implemented by the user device 701, and may correspond with the application server 707 to perform various functions of the mobile application. As an example, the mobile application may receive input of user credentials (e.g., a username and a password) by a user of the user device 701, and may send the user credentials (e.g., as encrypted for security purposes) to the application server 707 for authentication. The application server 707 may then verify the user credentials based on authentication functionalities of the application server 707, and may notify the mobile application of the verification results.

The internal network 709 may comprise a network that may be used by, managed by, owned by, and/or otherwise associated with a user group (e.g., an enterprise organization). Resources located within the internal network 709 may be intended to be used or accessed by authorized users (e.g., members of the enterprise organization). The internal network 709 may comprise, for example, a private network, a secure network, a network configured to block unauthorized access from outside of the network, and/or the like. In some examples, a firewall may be established between the network 703 (e.g., the Internet) and the internal network 709, and may be used to monitor, filter, and/or control incoming traffic to the internal network 709 from the network 703 and/or outgoing traffic from the internal network 709 to the network 703. In some examples, the internal network 709 may include physical computing devices located on the user group's premises, virtual machines hosted on the cloud (e.g., provided by a cloud vendor), or a combination of both types of components.

The internal network 709 may comprise the gateway device 711 and the servers 713A-713C. In some examples, a firewall (e.g., for the security of the internal network 709) may be established between the network 703 and the gateway device 711. In some examples, the gateway device 711 may be implemented between the network 703 and the internal network 709 comprising the servers 713A-713C. And a firewall (e.g., for the security of the internal network 709) may be established between the network 703 and the gateway device 711, and a firewall (e.g., for the security of the internal network 709) may be established between the gateway device 711 and the internal network 709 comprising the servers 713A-713C. Each of the servers 713A-713C may comprise any type of computing device, such as a web server, an application server, a file server, an email server, a server configured to host virtual desktops and/or virtual applications, and/or the like.

The gateway device 711 may comprise an intermediate device sitting between the network 703 and the servers 713A-713C. The gateway device 711 may comprise one computing device or a plurality of computing devices. In some examples, the gateway device 711 may comprise one or more functionalities of the access gateway 560 and/or the gateway server 606 (including its gateway services) as discussed in connection with FIGS. 5-6.

For example, the gateway device 711 may implement authentication functionalities. The gateway device 711 may be configured to authenticate user login requests based on user credentials (e.g., usernames and passwords). In some examples, the gateway device 711, after successful authentication of a user login request, may provide an authentication token (e.g., a single sign-on token) to the entity (e.g., an application) from which the user attempted to log in. The authentication token may be used for authenticating future communications initiated by the user (e.g., from another application) to the gateway device 711.

Additionally or alternatively, the gateway device 711 may implement access functionalities. The gateway device 711 may be configured to function as an access point for virtual private network (VPN) connections. For example, a user device may establish a VPN connection with the gateway device 711 to access the internal network 709 and/or resources located within the internal network 709 (such as the servers 713A-713C). In some examples, the gateway device 711 may be configured to facilitate the establishment of VPN connections wherein the end points of such a VPN connection between the a user device and the internal network 709 may be limited to particular application(s) implemented by the user device and/or particular resource(s) located within the internal network 709, such as micro-VPN connections and/or the like. For example, an application implemented by the user device may establish a VPN connection via the gateway device 711 to a particular server in the internal network 709, and the VPN connection might not extend to other applications implemented by the user device and might not extend to other servers in the internal network 709.

A user may use an application (e.g., implemented by the user device 701) to access resources of the internal network 709. For example, the application may receive user input of an identifier of the internal network 709 (e.g., a domain name of the internal network 709, a URL pointing to the internal network 709, an IP address pointing to the internal network 709, etc.), an identifier of a user of the internal network 709, and/or the like, and may use the information to initiate a connection with the gateway device 711. The application may receive user input of user credentials (e.g., a username and a password) and may, based on the user credentials, authenticate to the gateway device 711. Based on the authentication, the application may establish a VPN connection via the gateway device 711 to access one or more resources of the internal network 709.

Users in the user group of the internal network 709 may also use other applications (e.g., a messaging application). For example, a first user may send, via a messaging application and to a second user, a link to a website (e.g., the link comprising a URL). In some examples, the link may comprise an external link (e.g., pointing to resource(s) accessible via the public network, such as the Internet). The second user may click the link, and may use any type of web browsing functionality to access the resource(s) identified by the link and to render the corresponding web page. In some examples, the link may comprise an internal link (e.g., pointing to resource(s) within the internal network 709). Because the resource(s) identified by the internal link may be located within the internal network 709, a web browsing functionality might not be able to access the resource(s), for example, if a VPN connection is not established for the web browsing functionality to access the resource(s). The web browsing functionality may use a VPN connection to access the resource(s) of the internal network. If each of the other applications is configured to implement a VPN connection with the internal network 709, and/or if a device-wide VPN connection is implemented that allows applications running on a device to access resource(s) of the internal network 709, it may contribute to added overhead of maintaining additional program code for the other applications, and/or added security risks due to expanded opportunities to access the internal network 709.

Using an application custom tab to access internal network resources may help alleviate the challenges as discussed above. A first application implemented on a computing device may present a link pointing to resource(s) of an internal network. After selection of the link, a web browsing tab of a second application may be used to access the link and to render the web page corresponding to the link. The second application may comprise, for example, an application dedicated to facilitating access to the internal network. The web browsing tab may establish a VPN connection with the internal network, and may access, via the VPN connection, the resource(s) of the internal network. The first application may configure and/or customize the web browsing tab of the second application, such that the web browsing tab of the second application may have a look and feel same as or substantially similar to the first application. Using the application custom tab to access internal network resources may reduce the overhead of maintaining program code (e.g., related to establishing VPN connections) for various applications other than the second application, reduce security risks to the internal network, and/or facilitate a seamless user experience (e.g., with reduced context switching from the user's perspective) in accessing internal network resources.

Additionally or alternatively, policy configurations may be applied to the application custom tab for accessing internal network resources. The policy configurations may be adjusted by an administrator and/or any other authorized person (e.g., associated with the enterprise organization of the internal network), and may facilitate management of access to the internal network and/or management of devices and/or services in the context of an enterprise organization (e.g., enterprise mobility management). For example, the policy configurations may include blacklisting of untrusted applications for which the application custom tab features might not be used, and whitelisting of trusted applications for which the application custom tab features may be used. An administrator may be able to configure, using the blacklisting and/or whitelisting, which applications may use the application custom tab features. An administrator may be able to configure policies including restrictions on usage of the application custom tab, and/or configure policies including features of the application custom tab, wherein the restrictions and/or the features may be specific to particular URLs to be processed by the application custom tab.

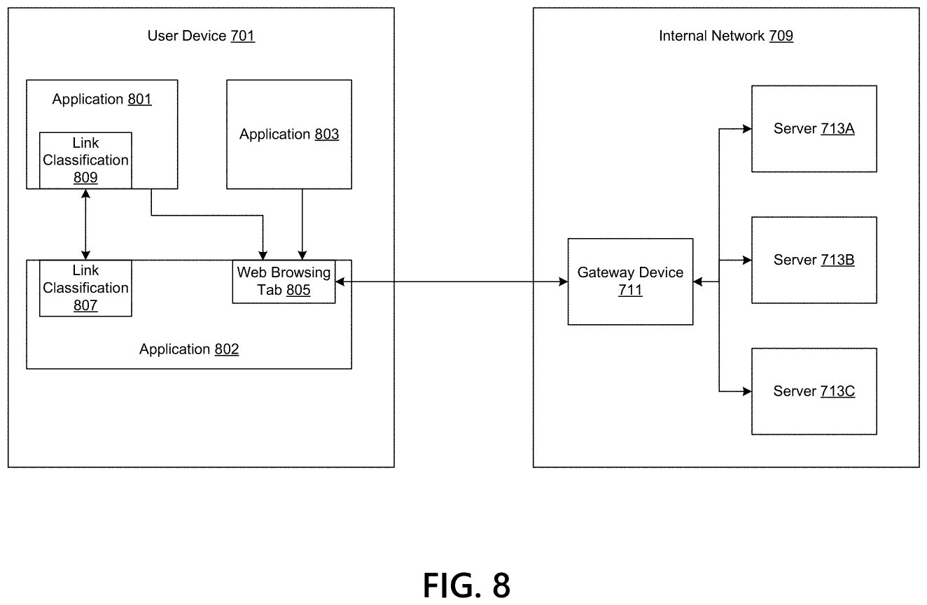

FIG. 8 is a schematic diagram showing an example system for accessing internal network resources using an application custom tab in accordance with one or more aspects described herein. The system may comprise, for example, the user device 701 and the internal network 709 (including the gateway device 711 and the servers 713A-713C). The user device 701 may implement one or more applications (e.g., applications 801, 802, 803). The user device 701 may implement one or more of various types of operating platforms or operating systems, based on which the one or more applications and/or other aspects as described herein may be executed. In some examples, the operating platforms or operating systems may comprise a mobile operating system, such as Android. In some examples, the operating platforms or operating systems may comprise iOS, or other types of mobile operating systems. Various aspects as described herein may be implemented in any type of suitable operating platform or operating system as desired by a person of ordinary skill in the art.

The application 802 may be used to access the internal network 709. In some examples, the application 802 may comprise an application dedicated to facilitating access to the internal network 709. The applications 801, 803 may comprise any type of application (e.g., messaging applications). In some examples, the applications 801-803 may comprise mobile applications.

The application 801 may comprise a link classification function 809. The application 802 may comprise a link classification function 807. The link classification function 807 may communicate with the link classification function 809 via an inter-application communication channel (e.g., inter-process communication (IPC)). In some examples, the application 801 may use to link classification function 809 to send, to the link classification function 807 of the application 802 and via the inter-application communication channel, a request to determine whether a particular link comprises an internal link associated with the internal network 709. And the application 801 may receive, from the application 802 and via the inter-application communication channel, a response indicating a determination by the application 802 of whether the particular link comprises an internal link associated with the internal network 709. The application 801 may, based on the response, determine whether to invoke the web browsing tab 805 of the application 802 for accessing the particular link.

In some examples, the link classification function 809 of the application 801 may be configured to send, to a server (e.g., the gateway device 711, another device in the internal network 709, and/or the like), a request to determine whether a particular link comprises an internal link associated with the internal network 709. The link classification function 809 of the application 801 may receive, from the server, a response to the request (the response including a determination by the server of whether the particular link comprises an internal link associated with the internal network 709), and the application 801 may use the response to determine whether to invoke the web browsing tab 805 of the application 802 for accessing the particular link.

The application 802 may comprise a web browsing tab 805. The web browsing tab 805 may be invoked by various applications (e.g., the applications 801, 803). An instance of the web browsing tab 805 to be invoked by a particular application may be configured and/or customized by the particular application, such that the instance of the web browsing tab 805 may have a look and feel same as or substantially similar to the particular application. The web browsing tab 805 may be configured to establish a VPN connection, via the gateway device 711, with the internal network 709 and/or with particular resource(s) of the internal network 709 (e.g., one or more of the servers 713A-713C). The VPN connection may be used by the web browsing tab 805 to access resource(s) of the internal network 709. In some examples, a user of the user device 701 may be able to adjust configurations of the web browsing tab 805 of the application 802. For example, the user may be able to, via settings, enable or disable the VPN functions of the web browsing tab 805. If the VPN functions of the web browsing tab 805 are enabled, the web browsing tab 805 may use the VPN functions (e.g., for accessing resources of the internal network 709). If the VPN functions of the web browsing tab 805 are disabled, the web browsing tab 805 may attempt to access resources of interest without the VPN functions (e.g., the web browsing tab 805 may attempt to access resources of interest directly via the public network, such as the Internet). In some examples, an administrator may configure policies enabling or disabling the VPN functions of the web browsing tab 805 for certain applications invoking the web browsing tab 805. In some examples, an administrator may configure policies allowing or not allowing the use of the web browsing tab 805 to access certain links and/or URLs.

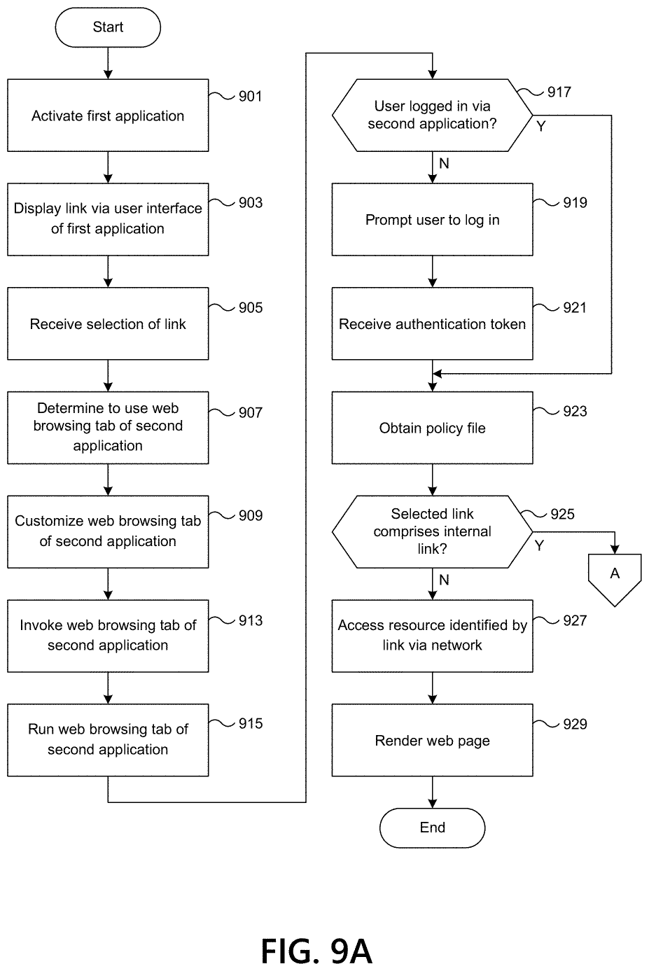

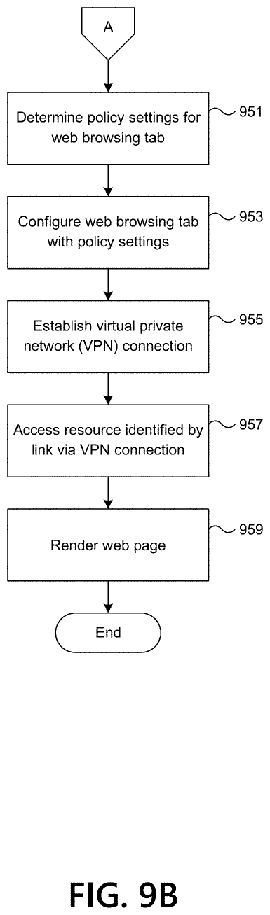

FIGS. 9A-9B show a flowchart of an example method for accessing internal network resources using an application custom tab in accordance with one or more aspects described herein. The method may be implemented or performed, for example, by one or more of the systems as discussed in connection with FIGS. 7-8. The method may be implemented or performed, for example, by one or more computing device. The steps of the method may be described as being performed by particular components and/or computing devices for the sake of simplicity, but the steps may be performed by any component and/or computing device, or by any combination of one or more components and/or one or more computing devices. The steps of the method may be performed by a single computing device or by multiple computing devices. One or more steps of the method may be omitted, added, rearranged, and/or otherwise modified as desired by a person of ordinary skill in the art.

In step 901, a computing device (e.g., the user device 701) may activate a first application (e.g., the application 803). The computing device may be owned by, managed by, used by, and/or otherwise associated with a user. The computing device may comprise a user interface, which may be configured to provide output information to the user, and/or receive input indications from the user. The first application may comprise, for example, a messaging application. The activation of the first application may be, for example, in response to the computing device receiving user input indicating selection of the first application (e.g., selection of an icon of the first application from a plurality of application icons displayed by the user interface). Based on the activation of the first application, the computing device may execute processes of the first application, a user interface of the first application may be displayed, and the user may interact with the first application via the user interface in various ways designed for the first application.

In step 903, the first application implemented by the computing device may display a link via the user interface of the first application. For example, the first application (e.g., a messaging application) may indicate, via its user interface, that a message for the user has been received from another user, the message comprising the link. The link may include a URL.

In step 905, the first application implemented by the computing device may receive selection of the link. For example, the first application may display link on its user interface, and a user may click the link. The user input corresponding to clicking the link may be received by the first application.

In step 907, the first application may determine to use a web browsing tab of a second application (e.g., the application 802) executable on the computing device for accessing the selected link. The first application may make this determination in various manners. For example, in response to the selection of the link, the first application may display a plurality of options (e.g., the web browsing tab of the second application, a web browser application, a custom tab of a web browser application, a web browsing functionality of the first application, and/or the like) for accessing the selected link. The user may select, from the plurality of options, the web browsing tab of the second application for accessing the selected link. The first application may receive the user input corresponding to the selection of the accessing option. The first application may, based on the user input, determine to use the web browsing tab of the second application for accessing the selected link. Additionally or alternatively, the user, an administrator, and/or any other authorized entity may configure the web browsing tab of the second application as the default option for the first application to access selected links. The first application may use the default option for accessing the link as selected in step 905.

In step 909, the first application may customize the web browsing tab of the second application. The web browsing tab of the second application may be customizable by different applications invoking the web browsing tab. One or more application programming interfaces (APIs) may be provided for configuring the customization parameters for the web browsing tab. The web browsing tab may allow an application to customize the look and feel of the web browsing tab. For example, the first application may configure the web browsing tab with respect to toolbar color, menu items, transition animations, etc. The first application may configure the web browsing tab of the second application in such a manner that the look and feel of the web browsing tab may be same as or substantially similar to the look and feel of the first application. For example, if the user interface of the first application uses a particular scheme (e.g., color scheme), the first application may configure and/or customize the web browsing tab to have a user interface with the same or substantially similar scheme (e.g., color scheme). Additionally or alternatively, if the user interface of the first application comprises images, logos, and/or other indications contributing to the look and feel of the first application, the first application may configure and/or customize the web browsing tab to have a user interface with the same or substantially similar images, logos, and/or other indications. Based on the configuration and/or customization, the first application may build the web browsing tab of the second application for the first application.

In step 913, the first application may invoke the web browsing tab of the second application (e.g., as configured, customized, and/or built in step 909). The web browsing tab of the second application may comprise an application programming interface (API) or any other type of interface that other applications may use to invoke the web browsing tab of the second application. The first application may invoke, using the API, the web browsing tab of the second application. The first application may provide the link as selected in step 905 to the web browsing tab in connection with the invoking of the web browsing tab. For example, the API for invoking the web browsing tab may allow the invoking application to input one or more parameters including a link to be opened by the web browsing tab.

In step 915, the computing device may run the web browsing tab of the second application, in response to the first application invoking the web browsing tab. The user interface of the first application that may be displayed before the invoking of the web browsing tab may be switched to a user interface of the web browsing tab, in response to the invoking of the web browsing tab. The transition animation for the switching may be configured by the first application (e.g., as part of the configuration processes as discussed in connection with step 909), by the second application, and/or by any other authorized entity. The transition animation for the switching may be same as or different from a transition animation for switching from one application to another application. In some examples, the transition animation for the switching from the first application to the web browsing tab may be less indicative of context switching from a user's perspective than the transition animation for switching from one application to another application. For example, the transition animation for the switching from the first application to the web browsing tab may be substantially similar to or same as a transition animation for switching between tabs, pages, windows, and/or other user interface elements of a single application.

The user interface of the web browsing tab may comprise an exit button for allowing the user to exit the web browsing tab. The exit button may have any shape as desired by a person of ordinary skill in the art, such as in the shape of the letter “X.” Clicking the exit button may cause the web browsing tab to exit, and may cause display of the user interface of the first application that was displayed before switching to the web browsing tab (e.g., the user interface including the content that was displayed before switching to the web browsing tab). For example, the web browsing tab may determine that it was the first application that invoked the web browsing tab, and the web browsing tab may invoke, and/or return the use of the user interface of the computing device back to, the first application when the web browsing tab exits. The transition animation for exiting the web browsing tab and switching back to the first application may be configured by the first application (e.g., as part of the configuration processes as discussed in connection with step 909), by the second application, and/or by any other authorized entity. The transition animation for the exiting and switching may be same as or different from a transition animation for switching from one application to another application. In some examples, the transition animation for the exiting and switching may be less indicative of context switching from a user's perspective than the transition animation for switching from one application to another application. For example, the transition animation for the exiting and switching may be substantially similar to or same as a transition animation for switching between tabs, pages, windows, and/or other user interface elements of a single application.

In some examples, the web browsing tab of the second application, after being invoked by the first application, may determine whether the first application is allowed to invoke the web browsing tab of the second application. If the first application is allowed to invoke the web browsing tab, the web browsing tab may run on the computing device in response to the invoking. If the first application is not allowed to invoke the web browsing tab of the second application, the web browsing tab may abort after being invoked by the first application. Whether the first application or any other application is allowed to invoke the web browsing tab of the second application may be determined based on policies specified by an administrator and/or any other authorized person. The policies may be received in connection with the installation and/or configuration of the second application on the computing device, and/or may be received at a later time. The policies may be reflected and/or stored in a policy file as described herein (e.g., as described in connection with step 923).

In step 917, the web browsing tab of the second application may determine whether a user is logged in via the second application. The second application may be configured to allow users to authenticate to an internal network (e.g., the internal network 709) and access resources of the internal network. The internal network may be, for example, a private network or a secure network owned by, managed by, used by, and/or otherwise associated with an enterprise organization. If a user successfully logs in via the second application, e.g., by authenticating, based on user credentials of the user (e.g., a username and a password), to a gateway device (e.g., the gateway device 711) and/or any other device having authentication functionalities of the internal network, the second application may receive an authentication token (e.g., a single sign-on token) in response to the successful logging in. Storing a valid, unexpired authentication token by the second application may indicate that a user is logged in via the second application. Additionally or alternatively, a status identifier may be stored and/or used by the second application to indicate whether a user is logged in via the second application. The web browsing tab may determine whether a user is logged in via the second application, for example, based on the authentication token and/or the status identifier. If a user is not logged in via the second application (step 917: N), the method may proceed to step 919. If a user is logged in via the second application (step 917: Y), the method may proceed to step 923.

In step 919, the web browsing tab may prompt the user of the computing device to log in. The web browsing tab may, for example, prompt the user to enter user credentials (e.g., a username and a password). The web browsing tab may receive user input of the user credentials. The web browsing tab may send the user credentials (e.g., as encrypted for security purposes) to the gateway device of the internal network for authentication.

In step 921, the web browsing tab may receive an authentication token (e.g., from the gateway device of the internal network). Receipt of the authentication token may be in response to the user credentials being successfully authenticated by the gateway device of the internal network. The authentication token may comprise any type of authentication credential, such as a single sign-on token and/or the like. In some examples, the authentication token may have a fixed lifetime after which the authentication token may become expired. The received authentication token may be stored by the second application (e.g., in a dedicated memory space for the second application), and may be secured (e.g., applications other than the second application might not be able to access the received authentication token as stored by the second application).

In some examples, the processes as described above in connection with step 919, 921 may be performed using another user interface of the second application, instead of the web browsing tab of the second application. For example, in response to determining that a user is not logged in via the second application in step 917, the web browsing tab of the second application may be switched to a user interface of the second application that may be used as the log-in page for the second application where the second application is directly activated (e.g., by selecting an icon for the second application from a list of application icons). After the user logs in using that user interface and/or an associated authentication token is received and stored, the computing device may switch back to the web browsing tab.

In some examples, after the user is prompted to log in, if the user fails the authentication with the internal network (e.g., if the user fails to provide the correct username and password), the web browsing tab of the second application might not proceed to processes for accessing the selected link and/or rendering the corresponding web page. In such a scenario, the user may be prompted to enter user credentials again, the user may be notified of the failure of authentication, the user may be notified that the selected link cannot be accessed by the user, and/or other procedures may follow as desired by a person of ordinary skill in the art.

In step 923, the web browsing tab of the second application may obtain a policy file. The policy file may include, for example, various types of configuration parameters for using the web browsing tab. The policy file may be in the format of one data file or multiple data files. For example, the policy file may indicate what URLs are identifying resources of the internal network. Additionally or alternatively, the policy file may indicate usage restrictions on the web browsing tab. The usage restrictions may be specific to the application invoking the web browsing tab, the link and/or URL to be accessed by the web browsing tab, and/or the identity of the authenticated user who may be using the web browsing tab.

For example, the policy file may indicate a usage restriction on whether copying content from the web browsing tab is allowed. In some examples, copying content from the web browsing tab might not be allowed if the web browsing tab is accessing and/or rendering a web page corresponding to an internal link (e.g., comprising a URL identifying a resource of the internal network). In some examples, the copying restriction may be different for different internal URLs (e.g., allowing copying when the web browsing tab is accessing one particular internal URL, but not allowing copying when the web browsing tab is accessing another internal URL). In some examples, different users may have different levels of authorization to copy from the web browsing tab. Additionally or alternatively, the policy file may indicate if watermarks may be added on web pages being rendered by the web browsing tab. Watermarks added on web pages rendered by the web browsing tab may be governed by settings configurable by an administrator. For example, watermarks may be added onto the web pages if the administrator activates the usage restriction. Watermarks might not be added onto the web pages if the administrator deactivates the usage restriction. A user might not be able to configure whether to add watermarks onto the web pages. Additionally or alternatively, the policy file may indicate a usage restriction on whether printing content from the web browsing tab (e.g., printing web pages rendered by the web browsing tab) is allowed. Additionally or alternatively, the policy file may indicate a usage restriction on whether downloading content from the web browsing tab is allowed. For example, the usage restriction may indicate whether downloading of resources on or indicated by web pages rendered by the web browsing tab is allowed. The policy file may indicate other types of usage restrictions as desired by a person of ordinary skill in the art.

Additionally or alternatively, the policy file may indicate a usage restriction on whether invoking the web browsing tab by a particular application is allowed. An administrator may configure policies such that certain applications may be allowed to invoke the web browsing tab, and certain other applications might not be allowed to invoke the web browsing tab. The policies may be configured, for example, based on security considerations surrounding the invoking applications, such as whether an invoking application may be considered to be a trusted application or to be an application posing a security risk to the second application. The policies may be reflected in the policy file, which may indicate whether a particular application is allowed to invoke the web browsing tab.

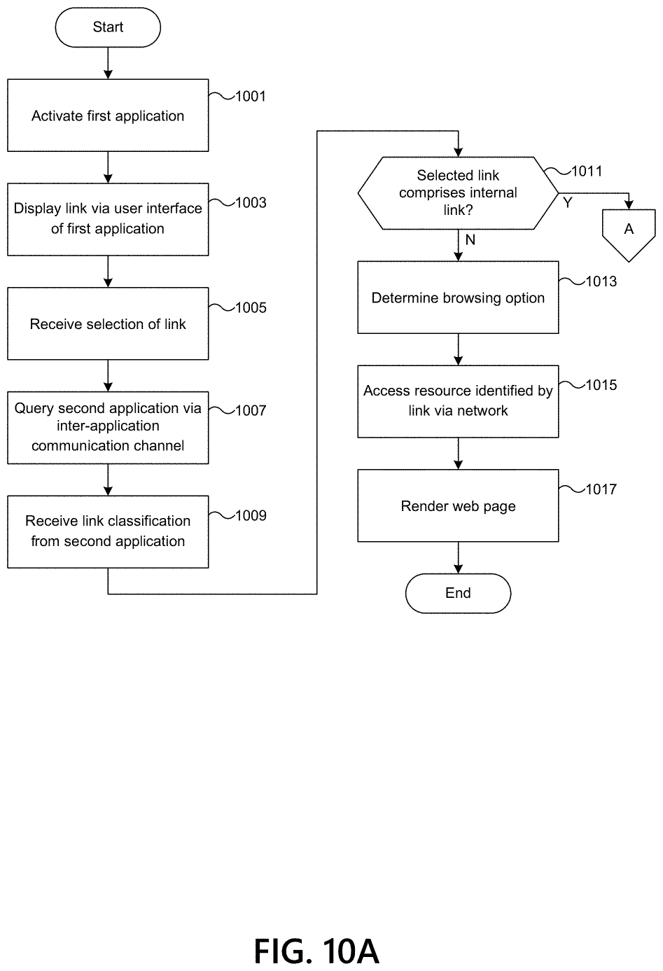

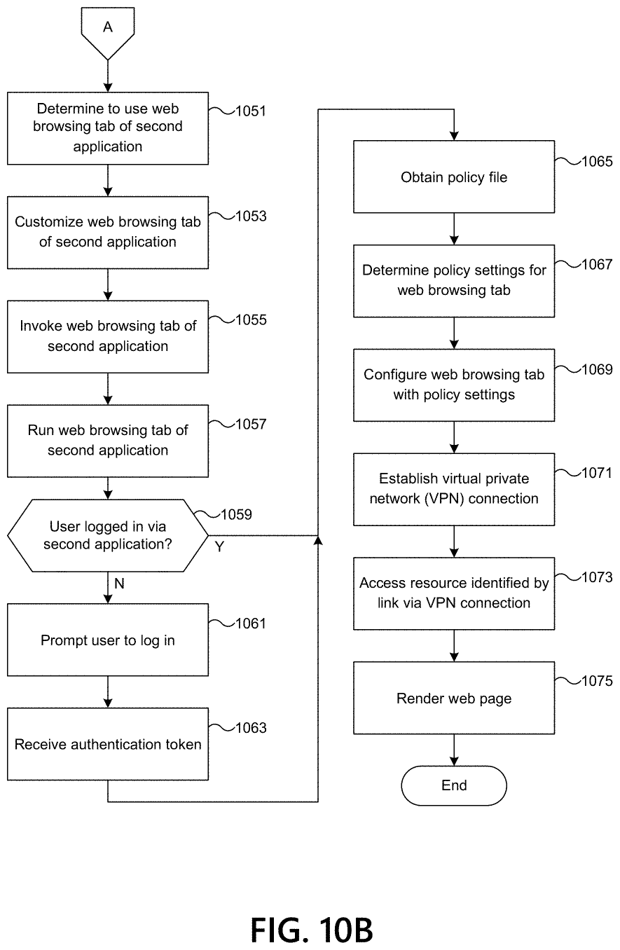

Additionally or alternatively, the policy file may indicate a usage restriction on whether a particular application is allowed to communicate with the second application via an inter-application communication channel. The inter-application communication channel may allow the second application to inform another application as to whether a particular link is an internal link or an external link (as discussed in greater detail below in connection with FIGS. 10A-10B), so that the other application may use that information to determine whether to invoke the web browsing tab of the second application. An administrator may configure policies such that certain applications may be allowed to communicate with the second application via the inter-application communication channel, and certain other applications might not be allowed to communicate with the second application via the inter-application communication channel. The policies may be configured, for example, based on security considerations surrounding the applications, such as whether an application may be considered to be a trusted application or to be an application posing a security risk to the second application. The policies may be reflected in the policy file, which may indicate whether a particular application is allowed to communicate with the second application via the inter-application communication channel.

The web browsing tab may receive the policy file, for example, from the gateway device of the internal network. In some example, the web browsing tab may receive the policy file from a policy server separate from the gateway device. The policy file may be requested, from a server, using the authentication token (e.g., as discussed in connection with steps 917, 921). In some examples, the policy file may have been previously received and stored by the second application, and may be retrieved by the web browsing tab for use. The policy file may be stored by the second application, for example, in a dedicated memory space for the second application, and/or may become inaccessible or be deleted from the computing device if the corresponding authentication token becomes invalid or expired. In some examples, one or more parts of the policy file may be requested and received from the server for use by particular upcoming processes of the second application, and one or more other parts of the policy file may be requested and received from the server afterwards (e.g., at a later time in a separate thread of communication) for use by different processes of the second application. For example, criteria for determining whether a link is an internal link may be requested and received for the processes as discussed below in connection of step 925.

In step 925, the web browsing tab of the second application may determine whether the link as selected in step 905 comprises an internal link. An internal link may be a link that points to a resource of the internal network (e.g., 709). The selected link may comprise a URL. The web browsing tab may extract the URL, and may determine whether the URL identifies a resource of the internal network. For example, the policy file as received in step 923 may indicate a list of URLs identifying resources of the internal network, and the web browsing tab may compare the extracted URL with the list for the determination of whether the selected link comprises an internal link. In some examples, the policy file may indicate one or more criteria for determining whether a particular URL identifies a resource of the internal network. As an example of such criteria, the presence of certain texts or strings relating to the internal network (e.g., a domain name or a substring of a domain name) in a particular URL may indicate that the URL identifies a resource of the internal network. In some examples, the selected link may comprise an IP address or any other type of information, and the web browsing tab may similarly determine whether the selected link comprises an internal link based on the information. If the selected link comprises an internal link (step 925: Y), the method may proceed to step 951 (FIG. 9B). If the selected link does not comprise an internal link (step 925: N), the method may proceed to step 927.

In step 927, the web browsing tab of the second application may access the resource identified by the selected link. The web browsing tab may access the resource via the public network (e.g., the Internet). For example, the web browsing tab may send a HTTP request to the server as pointed to by the selected link, to retrieve content corresponding to the link from the sever. The web browsing tab may receive a web page (e.g., in a HTTP response) from the server. In step 929, the web browsing tab of the second application may render the web page. For example, the web browsing tab may process HTML documents and/or other resources of the web page, and transform them into an interactive visual representation to be displayed by the user interface of the computing device.

In step 951 (FIG. 9B), policy settings for the web browsing tab of the second application may be determined. The policy settings may be specific to the application that invoked the web browsing tab (e.g., the first application), the link to be rendered by the web browsing tab (e.g., the link as selected in step 905), and/or the authenticated user who may be using the web browsing tab. The policy settings may include, for example, whether using clipboard copy and/or paste is allowed in the current instance of the web browsing tab that was invoked by the first application and is to render the selected link. Additionally or alternatively, the policy settings may include, for example, whether adding watermarks on rendered web pages is allowed in the current instance of the web browsing tab, whether printing content from the web browsing tab is allowed in the current instance of the web browsing tab, and/or whether downloading content from the web browsing tab is allowed in the current instance of the web browsing tab. The policy settings (e.g., on whether adding watermarks on rendered web pages is required in the current instance of the web browsing tab) may be configurable by an administrator. The policy settings may be determined based on the policy file as obtained in step 923. In some examples, the specific policy settings for the current instance of the web browsing tab may be requested and received from, for example, the gateway device of the internal network or a policy server (e.g., based on and/or in response to the determining that the selected link comprises an internal link).

In step 953, the web browsing tab of the second application may be configured with the policy settings. For example, based on the policy settings, the web browsing tab may be configured with respect to whether clipboard copy and/or paste may be allowed to be used in the current instance of the web browsing tab.

In step 955, the web browsing tab of the second application may establish a virtual private network (VPN) connection with the internal network. For example, the web browsing tab may use the authentication token (e.g., as discussed in connection with steps 917, 921) to authenticate to the gateway device of the internal network and, based on the authentication, establish a VPN connection with the gateway device, the VPN connection allowing the web browsing tab to access a server located in the internal network and identified by the selected link. Additionally or alternatively, a session cookie may be obtained from the gateway device of the internal network based on the authentication token, and the web browsing tab may use the session cookie to establish a VPN connection with the gateway device of the internal network. The session cookie may be used specifically for the current instance of the web browsing tab.

In some examples, the VPN connection may allow the web browsing tab to access all resources of the internal network (e.g., as if the computing device was directly connected to the internal network). In some examples, the VPN connection may be configured in such a manner that the web browsing tab may be able to access one or more particular resources of the internal network (e.g., the server as pointed to by the selected link), and might not be able to access other resources of the internal network. For example, the VPN connection may comprise a micro-VPN connection and/or the like. The gateway device of the internal network may be configured to facilitate the implementation of such a VPN connection, for example, by allowing traffic from the web browsing tab directed to a particular server of the internal network to be placed onto the internal network and by not allowing traffic from the web browsing tab directed to other servers of the internal network to be placed onto the internal network.

In step 957, the web browsing tab of the second application may access a resource identified by the selected link via the VPN connection. For example, the web browsing tab may send, via the VPN connection, a HTTP request to a server, of the internal network, as pointed to by the selected link, to retrieve content corresponding to the link from the sever. The web browsing tab may receive, via the VPN connection, a web page (e.g., in a HTTP response) from the server.

In step 959, the web browsing tab of the second application may render the web page. For example, the web browsing tab may process HTML documents and/or other resources of the web page, and transform them into an interactive visual representation to be displayed by the user interface of the computing device.

In some examples, the web site corresponding to the selected link may comprise its own login procedures. For example, the web site may prompt the user to enter user credentials for authenticating to the web site (e.g., before the user is allowed to browse the content of the web site). The authentication token (e.g., the single sign-on token), or the session cookie, that may be used to establish the VPN connection may be used to allow the user to skip the login procedures to the internal web site, when accessed using the web browsing tab of the second application. For example, the web browsing tab may use the authentication token and/or the session cookie to authenticate with the web site, which may be configured (e.g., in communication with the gateway device of the internal network) to recognize the authentication token and/or the session cookie as acceptable methods for authentication. Based on the authentication token and/or the session cookie, the user may be successfully authenticated to the web site, and may browse the content of the web site. Whether the authentication credentials used for establishing the VPN connection may be used for authentication to the web site may be controlled by an administrator via policy configurations in view of the web site's or the associated enterprise organization's network security considerations.

FIGS. 10A-10B show a flowchart of another example method for accessing internal network resources using an application custom tab in accordance with one or more aspects described herein. The method may be implemented or performed, for example, by one or more of the systems as discussed in connection with FIGS. 7-8. The method may be implemented or performed, for example, by one or more computing device. The steps of the method may be described as being performed by particular components and/or computing devices for the sake of simplicity, but the steps may be performed by any component and/or computing device, or by any combination of one or more components and/or one or more computing devices. The steps of the method may be performed by a single computing device or by multiple computing devices. One or more steps of the method may be omitted, added, rearranged, and/or otherwise modified as desired by a person of ordinary skill in the art.

In step 1001, a computing device (e.g., the user device 701) may activate a first application (e.g., the application 801). The computing device may be owned by, managed by, used by, and/or otherwise associated with a user. The computing device may comprise a user interface, which may be configured to provide output information to the user, and/or receive input indications from the user. The first application may comprise, for example, a messaging application. The activation of the first application may be, for example, in response to the computing device receiving user input indicating selection of the first application (e.g., selection of an icon of the first application from a plurality of application icons displayed by the user interface). Based on the activation of the first application, the computing device may execute processes of the first application, a user interface of the first application may be displayed, and the user may interact with the first application via the user interface in various ways designed for the first application. The processes of step 1001 may be performed in a similar manner as the processes as described in connection with step 901.

In step 1003, the first application implemented by the computing device may display a link via the user interface of the first application. For example, the first application (e.g., a messaging application) may indicate, via its user interface, that a message for the user has been received from another user, the message comprising the link. The link may include a URL. The processes of step 1003 may be performed in a similar manner as the processes as described in connection with step 903.

In step 1005, the first application implemented by the computing device may receive selection of the link. For example, the first application may display link on its user interface, and a user may click the link. The user input corresponding to clicking the link may be received by the first application. The processes of step 1005 may be performed in a similar manner as the processes as described in connection with step 905.

In step 1007, the first application implemented by the computing device may query a second application (e.g., the application 802) via an inter-application communication channel (e.g., inter-process communication (IPC)), for example, with respect to whether the selected link comprises an internal link associated with an internal network (e.g., the internal network 709). For example, an entity developing the second application may provide to trusted other applications a software development kit (SDK) for link classification. The first application may be provided with the link classification SDK and may implement the link classification SDK. The link classification SDK may allow the first application to communicate with the second application via an inter-application communication channel for determining whether a particular link comprises an internal link associated with the internal network. For example, the first application may send, via the inter-application communication channel and to the second application, a request to determine whether the link as selected in step 1005 comprises an internal link associated with the internal network. The request may comprise the selected link and/or a URL of the selected link.

In step 1009, the first application may receive, via the inter-application communication channel and from the second application, a link classification for the selected link. For example, after receiving the request, the second application may determine whether the link included in the request comprises an internal link associated with the internal network. An internal link may be a link that points to a resource of the internal network (e.g., 709). The selected link may comprise a URL. The second application may extract the URL, and may determine whether the URL identifies a resource of the internal network. For example, the second application may obtain, from the gateway device of the internal network and/or a policy server, a list of URLs identifying resources of the internal network, and the second application may compare the extracted URL with the list for the determination of whether the selected link comprises an internal link. In some examples, one or more criteria for determining whether a particular URL identifies a resource of the internal network may be obtained from the gateway device of the internal network and/or the policy server. As an example of such criteria, the presence of certain texts or strings relating to the internal network (e.g., a domain name or a substring of a domain name) in a particular URL may indicate that the URL identifies a resource of the internal network. In some examples, the selected link may comprise an IP address or any other type of information, and the second application may similarly determine whether the selected link comprises an internal link based on the information.

The rules used by the second application for determining whether a link comprises an internal link may be requested and received from a relevant server (e.g., the gateway device of the internal network) in response to the request received from the first application, or may be previously received from the server and stored by the second application for retrieval. In some examples, the rules may be accessible without having authenticated to the internal network. In some examples, the rules may be accessible if a user has authenticated to the internal network, and might not be accessible if a user is not in a status of being authenticated to the internal network. For example, the rules may be accessible if the second application has a valid, unexpired authentication token associated with a user and the internal network. The rules might not be accessible if the second application does not have a valid, unexpired authentication token associated with a user and the internal network.

If the second application determines that the selected link comprises an internal link, the second application may send, via the inter-application communication channel and to the first application, an indication of the determination. If the second application determines that the selected link does not comprise an internal link (e.g., but comprises an external link), the second application may send, via the inter-application communication channel and to the first application, an indication of the determination. If the second application does not make a determination as to whether the selected link comprises an internal link (e.g., if the second application does not have access to rules for making the determination), the second application may send, via the inter-application communication channel and to the first application, an indication that a determination of whether the selected link comprises an internal link is not made. The first application may receive the indication from the second application.

In some examples, the second application, after receiving the request from the first application via the inter-application communication channel, may determine whether the first application is allowed to communicate with the second application via the inter-application communication channel. If the first application is allowed to communicate with the second application via the inter-application communication channel, the second application may proceed with processing the request in response to receiving the request. If the first application is not allowed to communicate with the second application via the inter-application communication channel, the second application may return, to the first application and in response to receiving the request, an indication that the request cannot be processed by the second application due to the first application's lack of authorization to use the inter-application communication channel Whether the first application or any other application is allowed to communicate with the second application via the inter-application communication channel may be determined based on policies specified by an administrator and/or any other authorized person. The policies may be received in connection with the installation and/or configuration of the second application on the computing device, and/or may be received at a later time. The policies may be reflected and/or stored in a policy file as described herein (e.g., as described in connection with step 1065).

In some examples, the link classification SDK may allow the first application to communicate with a server (e.g., the gateway device of the internal network, another device in the internal network, and/or the like) for determining whether a particular link comprises an internal link associated with the internal network. The communication by the first application with the server may be performed and/or used in a similar manner as the communication by the first application with the second application via the inter-application communication channel, and may be applied with policy configurations (e.g., with respect to whether the communication by the first application with the server is allowed) similar to the policy configurations for the inter-application communication (e.g., with respect to whether the inter-application communication by the first application with the second application is allowed).

In some examples, usage of the link classification SDK may be monitored, and/or used for analytics. For example, the event of an application using the inter-application communication channel with the second application for classifying a particular link may be recorded. Such events may be recorded for various applications with the link classification SDK and/or for various other computing devices and/or users. The events may be sent to an analysis computing device for analysis. For example, based on the received events, the analysis computing device may determine a total number of computing devices, users, and/or instances of, using the inter-application communication channel and/or the link classification SDK, how many computing devices and/or users used the inter-application communication channel from one particular application to the second application, how many instances of using the inter-application communication channel from the one particular application to the second application are there during a period of time, how many computing devices and/or users used the inter-application communication channel from another particular application to the second application, how many instances of using the inter-application communication channel from the other particular application to the second application are there during a period of time, etc. The analytics may be displayed to and/or used by an administrator. Other types of analytics (e.g., user experience analytics) based on monitored data relating to the link classification SDK may be determined as desired by a person of ordinary skill in the art.

In step 1011, the first application may determine whether the link as selected in step 1005 comprises an internal link associated with the internal network. The first application may make the determination based on the indication received from the second application. If the selected link comprises an internal link (step 1011: Y), the method may proceed to step 1051 (FIG. 10B). If the selected link does not comprise an internal link (step 1001: N), the method may proceed to step 1013. In some examples, if the indication received from the second application indicates that a determination of whether the selected link comprises an internal link is not made, the method may proceed to step 1013. In some examples, if the indication received from the second application indicates that the first application's request to determine whether the selected link comprises an internal link cannot be processed by the second application due to the first application's lack of authorization to use the inter-application communication channel, the method may proceed to step 1013.

In step 1013, the first application may determine a browsing option for the selected link. For example, the first application may display a plurality of browsing options for the selected link, and may allow the user to select a browsing option from the plurality of browsing options. The plurality of browsing options may comprise, for example, a web browsing tab of the second application, a web browser application, a custom tab of a web browser application, a web browsing functionality of the first application, and/or the like. The user may select, from the plurality of browsing options, a browsing option for accessing the selected link. The first application may receive the user input corresponding to the selection of the browsing option. The first application may, based on the user input, determine to use the selected browsing option for accessing the selected link. Additionally or alternatively, the user, an administrator, and/or any other authorized entity may configure a particular browsing option (e.g., of the plurality of browsing options) as the default option for the first application to access selected links. The first application may use the default option for accessing the link as selected in step 1005.

In step 1015, the browsing option as determined in step 1013 may access the resource identified by the selected link. The determined browsing option may access the resource via the public network (e.g., the Internet). For example, the determined browsing option may send a HTTP request to the server as pointed to by the selected link, to retrieve content corresponding to the link from the sever. The determined browsing option may receive a web page (e.g., in a HTTP response) from the server. The processes of step 1015 may be performed in a similar manner as the processes as described in connection with step 927.

In step 1017, the browsing option as determined in step 1013 may render the web page. For example, the determined browsing option may process HTML documents and/or other resources of the web page, and transform them into an interactive visual representation to be displayed by the user interface of the computing device. The processes of step 1017 may be performed in a similar manner as the processes as described in connection with step 929.

In step 1051 (FIG. 10B), the first application may determine to use a web browsing tab of the second application for accessing the link as selected in step 1005 (e.g., based on and/or in response to the determination that the selected link comprises an internal link associated with the internal network). After the determination to use the web browsing tab of the second application for accessing the selected link, the method may proceed to step 1053.

Additionally or alternatively, based on and/or in response to the determination that the selected link comprises an internal link associated with the internal network, the first application may provide to the user a recommendation to use the web browsing tab of the second application for accessing the selected link. For example, the first application may display the recommendation and prompt the user to confirm to proceed with the recommended browsing option. The displayed recommendation may indicate to the user that the selected link is determined to be an internal link associated with the internal network and/or that it may be recommended to use the web browsing tab of the second application to access the selected link. The first application may display, in connection with the recommendation, additional or alternative browsing option(s) for user selection. The additional or alternative browsing option(s) may comprise, for example, a web browser application, a custom tab of a web browser application, a web browsing functionality of the first application, and/or the like. If the user selects the recommended browsing option (e.g., the web browsing tab of the second application), the method may proceed to step 1053. If the user selects a browsing option other than the recommended browsing option, the method may proceed to step 1015. In step 1015, the selected browsing option may attempt to access the selected link.

In step 1053, the first application may customize the web browsing tab of the second application. The web browsing tab of the second application may be customizable by different applications invoking the web browsing tab. One or more application programming interfaces (APIs) may be provided for configuring the customization parameters for the web browsing tab. The web browsing tab may allow an application to customize the look and feel of the web browsing tab. For example, the first application may configure the web browsing tab with respect to toolbar color, menu items, transition animations, etc. The first application may configure the web browsing tab of the second application in such a manner that the look and feel of the web browsing tab may be same as or substantially similar to the look and feel of the first application. For example, if the user interface of the first application uses a particular scheme (e.g., color scheme), the first application may configure and/or customize the web browsing tab to have a user interface with the same or substantially similar scheme (e.g., color scheme). Additionally or alternatively, if the user interface of the first application comprises images, logos, and/or other indications contributing to the look and feel of the first application, the first application may configure and/or customize the web browsing tab to have a user interface with the same or substantially similar images, logos, and/or other indications. Based on the configuration and/or customization, the first application may build the web browsing tab of the second application for the first application. The processes of step 1053 may be performed in a similar manner as the processes as described in connection with step 909.

In step 1055, the first application may invoke the web browsing tab of the second application (e.g., as configured, customized, and/or built in step 1053). The web browsing tab of the second application may comprise an application programming interface (API) or any other type of interface that other applications may use to invoke the web browsing tab of the second application. The first application may invoke, using the API, the web browsing tab of the second application. The first application may provide the link as selected in step 1005 to the web browsing tab in connection with the invoking of the web browsing tab. For example, the API for invoking the web browsing tab may allow the invoking application to input one or more parameters including a link to be opened by the web browsing tab. The processes of step 1055 may be performed in a similar manner as the processes as described in connection with step 913.

In step 1057, the computing device may run the web browsing tab of the second application, in response to the first application invoking the web browsing tab. The user interface of the first application that may be displayed before the invoking of the web browsing tab may be switched to a user interface of the web browsing tab, in response to the invoking of the web browsing tab. The transition animation for the switching may be configured by the first application (e.g., as part of the configuration processes as discussed in connection with step 1053), by the second application, and/or by any other authorized entity. The transition animation for the switching may be same as or different from a transition animation for switching from one application to another application. In some examples, the transition animation for the switching from the first application to the web browsing tab may be less indicative of context switching from a user's perspective than the transition animation for switching from one application to another application. For example, the transition animation for the switching from the first application to the web browsing tab may be substantially similar to or same as a transition animation for switching between tabs, pages, windows, and/or other user interface elements of a single application.

The user interface of the web browsing tab may comprise an exit button for allowing the user to exit the web browsing tab. The exit button may have any shape as desired by a person of ordinary skill in the art, such as in the shape of the letter “X.” Clicking the exit button may cause the web browsing tab to exit, and may cause display of the user interface of the first application that was displayed before switching to the web browsing tab (e.g., the user interface including the content that was displayed before switching to the web browsing tab). For example, the web browsing tab may determine that it was the first application that invoked the web browsing tab, and the web browsing tab may invoke, and/or return the use of the user interface of the computing device back to, the first application when the web browsing tab exits. The transition animation for exiting the web browsing tab and switching back to the first application may be configured by the first application (e.g., as part of the configuration processes as discussed in connection with step 1053), by the second application, and/or by any other authorized entity. The transition animation for the exiting and switching may be same as or different from a transition animation for switching from one application to another application. In some examples, the transition animation for the exiting and switching may be less indicative of context switching from a user's perspective than the transition animation for switching from one application to another application. For example, the transition animation for the exiting and switching may be substantially similar to or same as a transition animation for switching between tabs, pages, windows, and/or other user interface elements of a single application. The processes of step 1057 may be performed in a similar manner as the processes as described in connection with step 915.

In some examples, the web browsing tab of the second application, after being invoked by the first application, may determine whether the first application is allowed to invoke the web browsing tab of the second application. If the first application is allowed to invoke the web browsing tab, the web browsing tab may run on the computing device in response to the invoking. If the first application is not allowed to invoke the web browsing tab of the second application, the web browsing tab may abort after being invoked by the first application. Whether the first application or any other application is allowed to invoke the web browsing tab of the second application may be determined based on policies specified by an administrator and/or any other authorized person. The policies may be received in connection with the installation and/or configuration of the second application on the computing device, and/or may be received at a later time. The policies may be reflected and/or stored in a policy file as described herein (e.g., as described in connection with step 1065).

In step 1059, the web browsing tab of the second application may determine whether a user is logged in via the second application. The second application may be configured to allow users to authenticate to an internal network (e.g., the internal network 709) and access resources of the internal network. The internal network may be, for example, a private network or a secure network owned by, managed by, used by, and/or otherwise associated with an enterprise organization. If a user successfully logs in via the second application, e.g., by authenticating, based on user credentials of the user (e.g., a username and a password), to a gateway device (e.g., the gateway device 711) and/or any other device having authentication functionalities of the internal network, the second application may receive an authentication token (e.g., a single sign-on token) in response to the successful logging in. Storing a valid, unexpired authentication token by the second application may indicate that a user is logged in via the second application. Additionally or alternatively, a status identifier may be stored and/or used by the second application to indicate whether a user is logged in via the second application. The web browsing tab may determine whether a user is logged in via the second application, for example, based on the authentication token and/or the status identifier. The processes of step 1059 may be performed in a similar manner as the processes as described in connection with step 917. If a user is not logged in via the second application (step 1059: N), the method may proceed to step 1061. If a user is logged in via the second application (step 1059: Y), the method may proceed to step 1065.

In step 1061, the web browsing tab may prompt the user of the computing device to log in. The web browsing tab may, for example, prompt the user to enter user credentials (e.g., a username and a password). The web browsing tab may receive user input of the user credentials. The web browsing tab may send the user credentials (e.g., as encrypted for security purposes) to the gateway device of the internal network for authentication. The processes of step 1061 may be performed in a similar manner as the processes as described in connection with step 919.

In step 1063, the web browsing tab may receive an authentication token (e.g., from the gateway device of the internal network). Receipt of the authentication token may be in response to the user credentials being successfully authenticated by the gateway device of the internal network. The authentication token may comprise any type of authentication credential, such as a single sign-on token and/or the like. In some examples, the authentication token may have a fixed lifetime after which the authentication token may become expired. The received authentication token may be stored by the second application (e.g., in a dedicated memory space for the second application), and may be secured (e.g., applications other than the second application might not be able to access the received authentication token as stored by the second application). The processes of step 1063 may be performed in a similar manner as the processes as described in connection with step 921.

In some examples, the processes as described above in connection with step 1061, 1063 may be performed using another user interface of the second application, instead of the web browsing tab of the second application. For example, in response to determining that a user is not logged in via the second application in step 1059, the web browsing tab of the second application may be switched to a user interface of the second application that may be used as the log-in page for the second application where the second application is directly activated (e.g., by selecting an icon for the second application from a list of application icons). After the user logs in using that user interface and/or an associated authentication token is received and stored, the computing device may switch back to the web browsing tab.

In some examples, after the user is prompted to log in, if the user fails the authentication with the internal network (e.g., if the user fails to provide the correct username and password), the web browsing tab of the second application might not proceed to processes for accessing the selected link and/or rendering the corresponding web page. In such a scenario, the user may be prompted to enter user credentials again, the user may be notified of the failure of authentication, the user may be notified that the selected link cannot be accessed by the user, and/or other procedures may follow as desired by a person of ordinary skill in the art.

In step 1065, the web browsing tab of the second application may obtain a policy file. The policy file may include, for example, various types of configuration parameters for using the web browsing tab. The policy file may be in the format of one data file or multiple data files. For example, the policy file may indicate what URLs are identifying resources of the internal network. Additionally or alternatively, the policy file may indicate usage restrictions on the web browsing tab. The usage restrictions may be specific to the application invoking the web browsing tab, the link and/or URL to be accessed by the web browsing tab, and/or the identity of the authenticated user who may be using the web browsing tab.

For example, the policy file may indicate a usage restriction on whether copying content from the web browsing tab is allowed. In some examples, copying content from the web browsing tab might not be allowed if the web browsing tab is accessing and/or rendering a web page corresponding to an internal link (e.g., comprising a URL identifying a resource of the internal network). In some examples, the copying restriction may be different for different internal URLs (e.g., allowing copying when the web browsing tab is accessing one particular internal URL, but not allowing copying when the web browsing tab is accessing another internal URL). In some examples, different users may have different levels of authorization to copy from the web browsing tab. Additionally or alternatively, the policy file may indicate if watermarks may be added on web pages being rendered by the web browsing tab. Watermarks added on web pages rendered by the web browsing tab may be governed by settings configurable by an administrator. For example, watermarks may be added onto the web pages if the administrator activates the usage restriction. Watermarks might not be added onto the web pages if the administrator deactivates the usage restriction. A user might not be able to configure whether to add watermarks onto the web pages. Additionally or alternatively, the policy file may indicate a usage restriction on whether printing content from the web browsing tab (e.g., printing web pages rendered by the web browsing tab) is allowed. Additionally or alternatively, the policy file may indicate a usage restriction on whether downloading content from the web browsing tab is allowed. For example, the usage restriction may indicate whether downloading of resources on or indicated by web pages rendered by the web browsing tab is allowed. The policy file may indicate other types of usage restrictions as desired by a person of ordinary skill in the art.

Additionally or alternatively, the policy file may indicate a usage restriction on whether invoking the web browsing tab by a particular application is allowed. An administrator may configure policies such that certain applications may be allowed to invoke the web browsing tab, and certain other applications might not be allowed to invoke the web browsing tab. The policies may be configured, for example, based on security considerations surrounding the invoking applications, such as whether an invoking application may be considered to be a trusted application or to be an application posing a security risk to the second application. The policies may be reflected in the policy file, which may indicate whether a particular application is allowed to invoke the web browsing tab.

Additionally or alternatively, the policy file may indicate a usage restriction on whether a particular application is allowed to communicate with the second application via an inter-application communication channel. The inter-application communication channel may allow the second application to inform another application as to whether a particular link is an internal link or an external link, so that the other application may use that information to determine whether to invoke the web browsing tab of the second application. An administrator may configure policies such that certain applications may be allowed to communicate with the second application via the inter-application communication channel, and certain other applications might not be allowed to communicate with the second application via the inter-application communication channel. The policies may be configured, for example, based on security considerations surrounding the applications, such as whether an application may be considered to be a trusted application or to be an application posing a security risk to the second application. The policies may be reflected in the policy file, which may indicate whether a particular application is allowed to communicate with the second application via the inter-application communication channel.

The web browsing tab may receive the policy file, for example, from the gateway device of the internal network. In some example, the web browsing tab may receive the policy file from a policy server separate from the gateway device. The policy file may be requested, from a server, using the authentication token (e.g., as discussed in connection with steps 1059, 1063). In some examples, the policy file may have been previously received and stored by the second application, and may be retrieved by the web browsing tab for use. The policy file may be stored by the second application, for example, in a dedicated memory space for the second application, and/or may become inaccessible or be deleted from the computing device if the corresponding authentication token becomes invalid or expired. In some examples, one or more parts of the policy file may be requested and received from the server for use by particular upcoming processes of the second application, and one or more other parts of the policy file may be requested and received from the server afterwards (e.g., at a later time in a separate thread of communication) for use by different processes of the second application. For example, policy settings with respect to whether using clipboard copy and/or paste is allowed in the current instance of the web browsing tab, whether adding watermarks on rendered web pages is allowed in the current instance of the web browsing tab, whether printing content from the web browsing tab is allowed in the current instance of the web browsing tab, and/or whether downloading content from the web browsing tab is allowed in the current instance of the web browsing tab may be requested and received for the processes as discussed below in connection of step 1067. The processes of step 1065 may be performed in a similar manner as the processes as described in connection with step 923.

In step 1067, policy settings for the web browsing tab of the second application may be determined. The policy settings may be specific to the application that invoked the web browsing tab (e.g., the first application), the link to be rendered by the web browsing tab (e.g., the link as selected in step 1005), and/or the authenticated user who may be using the web browsing tab. The policy settings may include, for example, whether using clipboard copy and/or paste is allowed in the current instance of the web browsing tab that was invoked by the first application and is to render the selected link. Additionally or alternatively, the policy settings may include, for example, whether adding watermarks on rendered web pages is allowed in the current instance of the web browsing tab, whether printing content from the web browsing tab is allowed in the current instance of the web browsing tab, and/or whether downloading content from the web browsing tab is allowed in the current instance of the web browsing tab. The policy settings (e.g., on whether adding watermarks on rendered web pages is required in the current instance of the web browsing tab) may be configurable by an administrator. The policy settings may be determined based on the policy file as obtained in step 1065. In some examples, the specific policy settings for the current instance of the web browsing tab may be requested and received from, for example, the gateway device of the internal network or a policy server (e.g., based on and/or in response to the web browsing tab being invoked and/or the verification that the user is logged in). The processes of step 1067 may be performed in a similar manner as the processes as described in connection with step 951.

In step 1069, the web browsing tab of the second application may be configured with the policy settings. For example, based on the policy settings, the web browsing tab may be configured with respect to whether clipboard copy and/or paste may be allowed to be used in the current instance of the web browsing tab. The processes of step 1069 may be performed in a similar manner as the processes as described in connection with step 953.

In step 1071, the web browsing tab of the second application may establish a virtual private network (VPN) connection with the internal network. For example, the web browsing tab may use the authentication token (e.g., as discussed in connection with steps 1059, 1063) to authenticate to the gateway device of the internal network and, based on the authentication, establish a VPN connection with the gateway device, the VPN connection allowing the web browsing tab to access a server located in the internal network and identified by the selected link. Additionally or alternatively, a session cookie may be obtained from the gateway device of the internal network based on the authentication token, and the web browsing tab may use the session cookie to establish a VPN connection with the gateway device of the internal network. The session cookie may be used specifically for the current instance of the web browsing tab.

In some examples, the VPN connection may allow the web browsing tab to access all resources of the internal network (e.g., as if the computing device was directly connected to the internal network). In some examples, the VPN connection may be configured in such a manner that the web browsing tab may be able to access one or more particular resources of the internal network (e.g., the server as pointed to by the selected link), and might not be able to access other resources of the internal network. For example, the VPN connection may comprise a micro-VPN connection and/or the like. The gateway device of the internal network may be configured to facilitate the implementation of such a VPN connection, for example, by allowing traffic from the web browsing tab directed to a particular server of the internal network to be placed onto the internal network and by not allowing traffic from the web browsing tab directed to other servers of the internal network to be placed onto the internal network. The processes of step 1071 may be performed in a similar manner as the processes as described in connection with step 955.

In step 1073, the web browsing tab of the second application may access a resource identified by the selected link via the VPN connection. For example, the web browsing tab may send, via the VPN connection, a HTTP request to a server, of the internal network, as pointed to by the selected link, to retrieve content corresponding to the link from the sever. The web browsing tab may receive, via the VPN connection, a web page (e.g., in a HTTP response) from the server. The processes of step 1073 may be performed in a similar manner as the processes as described in connection with step 957.

In step 1075, the web browsing tab of the second application may render the web page. For example, the web browsing tab may process HTML documents and/or other resources of the web page, and transform them into an interactive visual representation to be displayed by the user interface of the computing device. The processes of step 1075 may be performed in a similar manner as the processes as described in connection with step 959.

In some examples, the web site corresponding to the selected link may comprise its own login procedures. For example, the web site may prompt the user to enter user credentials for authenticating to the web site (e.g., before the user is allowed to browse the content of the web site). The authentication token (e.g., the single sign-on token), or the session cookie, that may be used to establish the VPN connection may be used to allow the user to skip the login procedures to the internal web site, when accessed using the web browsing tab of the second application. For example, the web browsing tab may use the authentication token and/or the session cookie to authenticate with the web site, which may be configured (e.g., in communication with the gateway device of the internal network) to recognize the authentication token and/or the session cookie as acceptable methods for authentication. Based on the authentication token and/or the session cookie, the user may be successfully authenticated to the web site, and may browse the content of the web site. Whether the authentication credentials used for establishing the VPN connection may be used for authentication to the web site may be controlled by an administrator via policy configurations in view of the web site's or the associated enterprise organization's network security considerations.

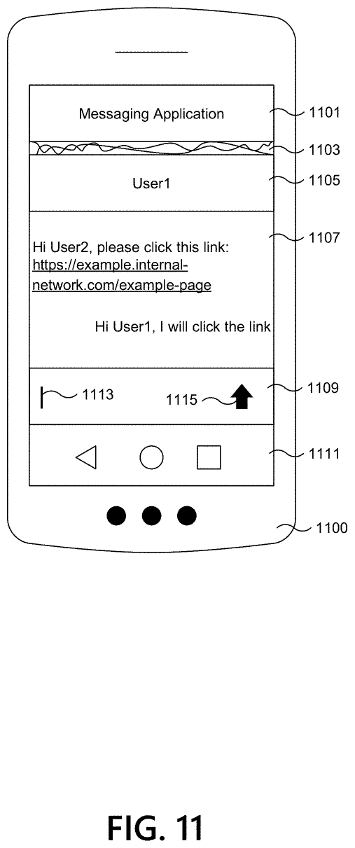

FIG. 11 shows an example user interface in accordance with one or more aspects described herein. The user interface may be displayed on a screen of a computing device 1100 (e.g., a smartphone). The user interface shows a first application (e.g., a messaging application). The user interface may comprise one or more sections (e.g., sections 1101, 1103, 1105, 1107, 1109, 1111). The section 1101 may indicate a name of the first application. The section 1103 may indicate information associated with the first application, such as a pattern and/or image providing a look and feel specific to the first application. The section 1105 may indicate a name of a user (e.g., User1) with whom the user of the computing device (e.g., User2) may be communicating. The section 1107 may indicate content of the communication between the users (e.g., User1 and User2). For example, User1 may send a message to User2, wherein the message may include a link. The section 1109 may indicate a text cursor 1113 that may allow the user of the computing device to input data. The section 1109 may indicate a send button 1115 that may allow the user of the computing device to send the input data by clicking the send button 1115. The section 1111 may indicate one or more buttons having functions as desired by a person of ordinary skill in the art.

The link included in the message from User1 to User2 as shown in the section 1107 may comprise an internal link (e.g., a link pointing to a resource of a private network or a secure network). The user of the computing device (e.g., User2) may click the link. The computing device may receive user input corresponding to the clicking of the link, and the computing device may process the user input to render a web page corresponding to the link in accordance with one or more of the processes as described in connection with FIGS. 9A-9B, 10A-10B.

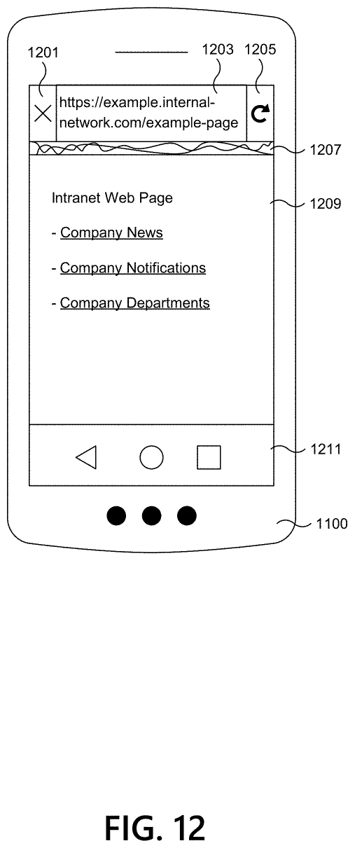

FIG. 12 shows another example user interface in accordance with one or more aspects described herein. The user interface may be displayed on the screen of the computing device 1100 (e.g., a smartphone). The user interface shows a web browsing tab of a second application (e.g., an application configured to facilitate access to one or more resources of a private network or a secure network). The user interface may be displayed in response to, based on, and/or after the clicking of the link as shown in the user interface of FIG. 11, in accordance with one or more of the processes as described in connection with FIGS. 9A-9B, 10A-10B. In some examples, the transition animation for switching from the user interface of FIG. 11 to the user interface of FIG. 12 may be less indicative of context switching than a transition animation for switching from the first application to any other application.

The user interface of FIG. 12 may comprise one or more sections (e.g., a top section, a section 1207, a section 1209, and a section 1211). The top section may indicate an exit button 1201, a URL indication 1203, and a refresh button 1205. Clicking the exit button 1201 may cause the web browsing tab of the second application to exit, and may cause the user interface of the first application (e.g., as shown in FIG. 11) to be displayed. The URL indication 1203 may indicate the URL as selected in the user interface of FIG. 11. The URL may be accessed, and the corresponding web page may be rendered, by the web browsing tab of the second application. Clicking the refresh button 1205 may cause the web browsing tab of the second application to refresh the web page corresponding to the URL of the URL indication 1203.

The section 1207 may indicate information associated with the first application, such as a pattern and/or image providing a look and feel specific to the first application. Content of the section 1207 may be same as or substantially similar to content of the section 1103. As described herein, the web browsing tab of the second application may be configured and/or customized by the first application. The web browsing tab may be configured to have a similar look and feel as the first application (e.g., as shown by the sections 1103, 1207, the formatting of the user interfaces, and/or other aspects of the user interfaces). The section 1209 may indicate the web page corresponding to the URL of the URL indication 1203. The web page may be retrieved and rendered by the web browsing tab. The section 1211 may indicate one or more buttons having functions as desired by a person of ordinary skill in the art.

The following paragraphs (M1) through (M12) describe examples of methods that may be implemented in accordance with the present disclosure.

(M1) A method comprising: receiving, by a first application implemented by a computing device, a selection of a link from a user interface of the first application; invoking, by the first application, a web browsing tab of a second application implemented by the computing device, wherein the web browsing tab is customized to the first application; determining, by the web browsing tab of the second application, that the link comprises an internal link associated with an internal network; based on the determining, establishing, by the web browsing tab, a virtual private network (VPN) connection with the internal network; accessing, by the web browsing tab and via the VPN connection, a resource identified by the link; and based on the accessing, rendering, by the web browsing tab, a web page associated with the link.

(M2) A method may be performed as described in paragraph (M1) wherein the invoking the web browsing tab comprises inputting, to the web browsing tab, the link.

(M3) A method may be performed as described in any of paragraphs (M1) through (M2) wherein the customization of the web browsing tab to the first application comprises adjusting, based on the user interface of the first application, a user interface of the web browsing tab.

(M4) A method may be performed as described in any of paragraphs (M1) through (M3) wherein a transition animation, displayed via a user interface, for switching from the first application to the web browsing tab is less indicative of context switching than a transaction animation, displayed via a user interface, for switching from the first application to another application.

(M5) A method may be performed as described in any of paragraphs (M1) through (M4) further comprising: authenticating, by the second application and based on user credentials, to an authentication server associated with the internal network; receiving, by the second application and from the authentication server, an authentication token; and requesting, by the second application, based on the authentication token, and for the web browsing tab, a session cookie, wherein the establishing the VPN connection with the internal network is based on the session cookie.

(M6) A method may be performed as described in any of paragraphs (M1) through (M5) further comprising: authenticating, by the second application and based on user credentials, to an authentication server associated with the internal network; and receiving, by the second application and from the authentication server, an authentication token, wherein the establishing the VPN connection with the internal network is based on the authentication token.

(M7) A method may be performed as described in any of paragraphs (M1) through (M6) further comprising: receiving, by a third application implemented by the computing device, a selection of a second link from a user interface of the third application; querying, by the third application and via an inter-application communication channel, the second application; based on the querying, determining, by the third application, whether the second link comprises an internal link associated with the internal network; and based on the determining whether the second link comprises an internal link associated with the internal network, determining, by the third application, whether to invoke a web browsing tab, of the second application, customized to the third application.

(M8) A method may be performed as described in any of paragraphs (M1) through (M7) wherein the link comprises a uniform resource locator (URL).

(M9) A method may be performed as described in any of paragraphs (M1) through (M8) further comprising: receiving, by the second application, a policy file indicating restrictions on use of the web browsing tab, the restrictions being specific to one or more of applications, links, or users.

(M10) A method may be performed as described in paragraph (M9) wherein the use of the web browsing tab comprises one or more of: invoking the web browsing tab; copying content from the web browsing tab; adding watermarks on web pages rendered by the web browsing tab; printing content from the web browsing tab; downloading content from the web browsing tab; or communicating via an inter-application communication channel with the second application.

(M11) A method may be performed as described in any of paragraphs (M1) through (M10) wherein the internal network comprises a private network of an enterprise organization.

(M12) A method may be performed as described in any of paragraphs (M1) through (M11) wherein the VPN connection comprises a first end point and a second end point, wherein the first end point is limited to the web browsing tab, and wherein the second end point is limited to the resource.

The following paragraphs (A1) through (A4) describe examples of computing devices that may be implemented in accordance with the present disclosure.

(A1) A computing device comprising: one or more processors; and memory storing instructions that, when executed by the one or more processors, cause the computing device to: receive, using a first application implemented by the computing device, a selection of a link from a user interface of the first application; invoke, using the first application, a web browsing tab of a second application implemented by the computing device, wherein the web browsing tab is customized to the first application; determine, using the web browsing tab of the second application, that the link comprises an internal link associated with an internal network; based on the determining, establish, using the web browsing tab, a virtual private network (VPN) connection with the internal network; access, using the web browsing tab and via the VPN connection, a resource identified by the link; and based on the accessing, render, using the web browsing tab, a web page associated with the link.

(A2) A computing device may be implemented as described in paragraph (A1) wherein the customization of the web browsing tab to the first application comprises adjusting, based on the user interface of the first application, a user interface of the web browsing tab.

(A3) A computing device may be implemented as described in any of paragraphs (A1) through (A2) wherein a transition animation, displayed via a user interface, for switching from the first application to the web browsing tab is less indicative of context switching than a transaction animation, displayed via a user interface, for switching from the first application to another application.

(A4) A computing device may be implemented as described in any of paragraphs (A1) through (A3) wherein the internal network comprises a private network of an enterprise organization.

The following paragraphs (CRM1) through (CRM4) describe examples of computer-readable media that may be implemented in accordance with the present disclosure.

(CRM1) A non-transitory computer-readable medium storing instructions that, when executed, cause a computing device to: receive, using a first application implemented by the computing device, a selection of a link from a user interface of the first application; invoke, using the first application, a web browsing tab of a second application implemented by the computing device, wherein the web browsing tab is customized to the first application; determine, using the web browsing tab of the second application, that the link comprises an internal link associated with an internal network; based on the determining, establish, using the web browsing tab, a virtual private network (VPN) connection with the internal network; access, using the web browsing tab and via the VPN connection, a resource identified by the link; and based on the accessing, render, using the web browsing tab, a web page associated with the link.

(CRM2) A non-transitory computer-readable medium may be implemented as described in paragraph (CRM1) wherein the customization of the web browsing tab to the first application comprises adjusting, based on the user interface of the first application, a user interface of the web browsing tab.

(CRM3) A non-transitory computer-readable medium may be implemented as described in any of paragraphs (CRM1) through (CRM2) wherein a transition animation, displayed via a user interface, for switching from the first application to the web browsing tab is less indicative of context switching than a transaction animation, displayed via a user interface, for switching from the first application to another application.

(CRM4) A non-transitory computer-readable medium may be implemented as described in any of paragraphs (CRM1) through (CRM3) wherein the internal network comprises a private network of an enterprise organization.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

1. A method comprising:
receiving, by a first application implemented by a computing device, a selection of a link from a user interface of the first application;
invoking, by the first application, a web browsing tab of a second application implemented by the computing device, wherein the web browsing tab is customized to the first application;
retrieving one or more policy settings specific to the first application invoking the web browser tab;
determining, by the web browsing tab of the second application and based on the one or more policy settings, that the link comprises an internal link associated with an internal network;
based on the determining, establishing, by the web browsing tab, a virtual private network (VPN) connection with the internal network;
accessing, by the web browsing tab and via the VPN connection, a resource identified by the link; and
based on the accessing, rendering, by the web browsing tab, a web page associated with the link.

2. The method of claim 1, wherein the invoking the web browsing tab comprises inputting, to the web browsing tab, the link.

3. The method of claim 1, wherein the customization of the web browsing tab to the first application comprises adjusting, based on the user interface of the first application, a user interface of the web browsing tab.

4. The method of claim 1, wherein a transition animation, displayed via a user interface, for switching from the first application to the web browsing tab is less indicative of context switching than a transaction animation, displayed via a user interface, for switching from the first application to another application.

5. The method of claim 1, further comprising:
authenticating, by the second application and based on user credentials, to an authentication server associated with the internal network;
receiving, by the second application and from the authentication server, an authentication token; and
requesting, by the second application, based on the authentication token, and for the web browsing tab, a session cookie,
wherein the establishing the VPN connection with the internal network is based on the session cookie.

6. The method of claim 1, further comprising:
authenticating, by the second application and based on user credentials, to an authentication server associated with the internal network; and
receiving, by the second application and from the authentication server, an authentication token,
wherein the establishing the VPN connection with the internal network is based on the authentication token.

7. The method of claim 1, further comprising:
receiving, by a third application implemented by the computing device, a selection of a second link from a user interface of the third application;
querying, by the third application and via an inter-application communication channel, the second application;
based on the querying, determining, by the third application, whether the second link comprises an internal link associated with the internal network; and
based on the determining whether the second link comprises an internal link associated with the internal network, determining, by the third application, whether to invoke a web browsing tab, of the second application, customized to the third application.

8. The method of claim 1, wherein the link comprises a uniform resource locator (URL).

9. The method of claim 1,
wherein the one or more policy settings comprise a usage restriction on the first application.

10. The method of claim 9, wherein the use of the web browsing tab comprises one or more of:
invoking the web browsing tab;
copying content from the web browsing tab;
adding watermarks on web pages rendered by the web browsing tab;
printing content from the web browsing tab;
downloading content from the web browsing tab; or
communicating via an inter-application communication channel with the second application.

11. The method of claim 1, wherein the internal network comprises a private network of an enterprise organization.

12. The method of claim 1, wherein the VPN connection comprises a first end point and a second end point, wherein the first end point is limited to the web browsing tab, and wherein the second end point is limited to the resource.

13. A computing device comprising:
one or more processors; and
memory storing instructions that, when executed by the one or more processors, cause the computing device to:
receive, using a first application implemented by the computing device, a selection of a link from a user interface of the first application;
invoke, using the first application, a web browsing tab of a second application implemented by the computing device, wherein the web browsing tab is customized to the first application;
retrieving one or more policy settings specific to the first application invoking the web browser tab;
determine, using the web browsing tab of the second application and based on the one or more policy settings, that the link comprises an internal link associated with an internal network;
based on the determining, establish, using the web browsing tab, a virtual private network (VPN) connection with the internal network;
access, using the web browsing tab and via the VPN connection, a resource identified by the link; and
based on the accessing, render, using the web browsing tab, a web page associated with the link.

14. The computing device of claim 13, wherein the customization of the web browsing tab to the first application comprises adjusting, based on the user interface of the first application, a user interface of the web browsing tab.

15. The computing device of claim 13, wherein a transition animation, displayed via a user interface, for switching from the first application to the web browsing tab is less indicative of context switching than a transaction animation, displayed via a user interface, for switching from the first application to another application.

16. The computing device of claim 13, wherein the internal network comprises a private network of an enterprise organization.

17. One or more non-transitory computer-readable media storing instructions that, when executed, cause a computing device to:
receive, using a first application implemented by the computing device, a selection of a link from a user interface of the first application;
invoke, using the first application, a web browsing tab of a second application implemented by the computing device, wherein the web browsing tab is customized to the first application;
retrieving one or more policy settings specific to the first application invoking the web browser tab;
determine, using the web browsing tab of the second application and based on the one or more policy settings, that the link comprises an internal link associated with an internal network;
based on the determining, establish, using the web browsing tab, a virtual private network (VPN) connection with the internal network;
access, using the web browsing tab and via the VPN connection, a resource identified by the link; and
based on the accessing, render, using the web browsing tab, a web page associated with the link.

18. The one or more non-transitory computer-readable media of claim 17, wherein the customization of the web browsing tab to the first application comprises adjusting, based on the user interface of the first application, a user interface of the web browsing tab.

19. The one or more non-transitory computer-readable media of claim 17, wherein a transition animation, displayed via a user interface, for switching from the first application to the web browsing tab is less indicative of context switching than a transaction animation, displayed via a user interface, for switching from the first application to another application.

20. The one or more non-transitory computer-readable media of claim 17, wherein the internal network comprises a private network of an enterprise organization.
